(19) United States
(12) Patent Application Publication
(10) Pub. No.: US 2018/0285474 A1
(43) Pub. Date: Oct. 4, 2018

(54) THIRD-PARTY-SITE INTEROPERABILITY USING PUBLICATION AND INTERACTIVE DISCUSSION ENGINE

(71) Applicant: Stagwell Technologies, Inc., CORAL GABLES, FL (US)

(72) Inventors: Richard Oh, Toronto (CA); Peter L. Corsell, Miami Beach, FL (US); Robert Oh, Scarborough (CA)

(73) Assignee: Stagwell Technologies, Inc., CORAL GABLES, FL (US)

(21) Appl. No.: 15/782,654

(22) Filed: Oct. 12, 2017

Related U.S. Application Data
(60) Provisional application No. 62/407,296, filed on Oct. 12, 2016.

(51) Int. Cl. G06F 17/30; H04L 29/08; G06F 3/0482

(52) U.S. Cl. CPC G06F 17/30905; G06F 17/30893; G06Q 50/01; H04L 67/327; G06F 3/0482; H04L 67/20

(57) ABSTRACT

Disclosed is a system comprising a machine, useful in serving web pages, that provides a publication engine which allows building of dynamic, interactive topic pages on a Brand's site, and further allows the Brand to publish dynamic, interactive topic pages on third-party sites. In an embodiment, the system includes a data store containing data for populating a front end interface and a computer system having at least one server with a physical data processor operatively coupled to the data store. The physical data processor is programmed to receive data representing a topic via a computer network from a Brand user, the topic having been selected by the Brand user and relating a product or service of the Brand; receive across the network an identification from the Brand user of multiple forms of interactive content that pertains to the topic; build one or more web-accessible topic pages having dynamic content that is relevant to the topic along with interactive means for provoking participation of multiple users regarding the topic and the content; transmit the one or more web-accessible topic pages across the network to the user's computer for display; receive from a third party an identification of a web site of the third party into which at least a portion of the one or more web-accessible topic pages are to be integrated; and, in response to a content request from a server running the third party web site, send to the server of the third party web site content of the at least a portion of the one or more web-accessible topic pages for integration into the page requested by the end user.

This application is a non-provisional of and claims priority to U.S. Provisional Application No. 62/407,296 filed Oct. 12, 2016, the entire disclosure of which is incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present invention relates in general to the field of publishing and interactive content management, and in particular systems and methods for providing third party site integration in connection with interactive discussion engines.

### BRIEF DESCRIPTION OF THE DRAWINGS

Further objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 shows a graphical user interface illustrating an initial screen prior to login in accordance with an embodiment.

FIG. 2 shows a graphical user interface illustrating an initial screen after login in accordance with an embodiment.

FIG. 3 shows a graphical user interface illustrating a topic creation screen in accordance with an embodiment.

FIG. 4 shows a graphical user interface illustrating a topic creation screen in accordance with an embodiment.

FIG. 5A shows a graphical user interface illustrating a topic feature selection screen in accordance with an embodiment.

FIG. 5B shows a graphical user interface illustrating a topic feature selection screen in accordance with an alternate embodiment.

FIG. 6 shows a graphical user interface illustrating a topic feature selection screen in accordance with an alternate embodiment.

FIG. 7 shows a graphical user interface illustrating a topic tag gathering screen in accordance with an alternate embodiment.

FIG. 8 shows a graphical user interface illustrating a topic tag selection screen in accordance with an alternate embodiment.

FIG. 9 shows a graphical user interface illustrating a topic tag selection screen in accordance with an alternate embodiment.

FIG. 10 shows a graphical user interface illustrating a topic review screen in accordance with an alternate embodiment.

FIG. 11 shows a graphical user interface illustrating a topic creation wait screen in accordance with an alternate embodiment.

FIGS. 12A and 12B show the top and bottom, respectively, of a published topic page in accordance with an embodiment.

FIG. 13 shows a graphical user interface illustrating a poll creation portion of a published topic page in accordance with an embodiment.

FIG. 14 shows a graphical user interface illustrating a poll portion of a published topic page in accordance with an embodiment.

FIG. 15 illustrates a home page in accordance with the social-search embodiment.

FIG. 16 shows an initial results page for an exemplary search in accordance with the social search embodiment.

FIG. 16A shows a results page after a thumbnail has been selected from FIG. 16.

FIG. 17 shows an example of a dialog box that allows a user to add content to search results.

FIG. 18 shows an example of a search results page after the user has added content.

FIGS. 19-21 show pages illustrating a debate feature in accordance with an embodiment.

FIGS. 22-29 show examples of pages generated by a system that integrates a publication and interactive discussion engine with a media service.

FIGS. 30-34 show examples of pages generated by a publication and interactive discussion engine.

FIG. 35 shows an example of a page generated by a system that integrates a publication and interactive discussion engine with a financial information site.

FIG. 36 shows an example of a page for presenting offers of compensation an owner/curator of a topic page for publishing a piece of sponsor content on his or her topic page.

FIG. 37 shows an example of a page presenting a draft version of an owner/curator's topic page.

FIG. 38 shows an example of a page presenting an interface for rating/approving a draft prospective sponsored article.

FIG. 39 shows an example of a page presenting an interface for rating/approving images associated with a draft prospective sponsored article.

FIG. 40 shows an example of a page presenting a published version of an owner/curator's topic page.

FIG. 41 shows an example of a page presenting an interface that allows a user to license out photographs that he or she has uploaded to the system to third parties.

FIG. 42 shows an example of a page appearing on a brand's site that provides a topic community around the brand's products or services.

FIG. 43 shows an example of a page appearing on a brand's partner's site.

FIG. 44 shows an example of a page illustrating automatic or manually embedded content in a partner or brand's social stream.

FIGS. 45A and 45B show an example of a page illustrating using a retailer as the partner that is co-promoting with a brand.

FIG. 46 shows an example of a page illustrating an example a node on a retailer's site.

FIG. 47 shows an example of a page illustrating a master central node on the brand's site.

### DETAILED DESCRIPTION

Reference will now be made in detail to the preferred embodiments of the present invention, examples of which are illustrated in the accompanying drawings.

The present invention is described below with reference to diagrams and operational illustrations of methods and devices to populate web pages with content and a user interface in accordance with an end-user-specified topic. It is understood that each step illustrated in the diagrams or operational illustrations, and combinations of steps in the diagrams or operational illustrations, may be implemented by means of analog or digital hardware and computer program instructions. These computer program instructions may be stored on computer-readable media and provided to a processor of a computer, special purpose computer, ASIC, or other programmable data processing apparatus, such that the instructions, which execute via the processor of the computer or other programmable data processing apparatus, implements the functions/acts specified in the diagrams and textual description thereof. In some alternate implementations, the functions/acts noted in the diagrams may occur out of the order noted in the operational illustrations. For example, two steps shown in succession may in fact be executed substantially concurrently or the steps may sometimes be executed in the reverse order, depending upon the functionality/acts involved.

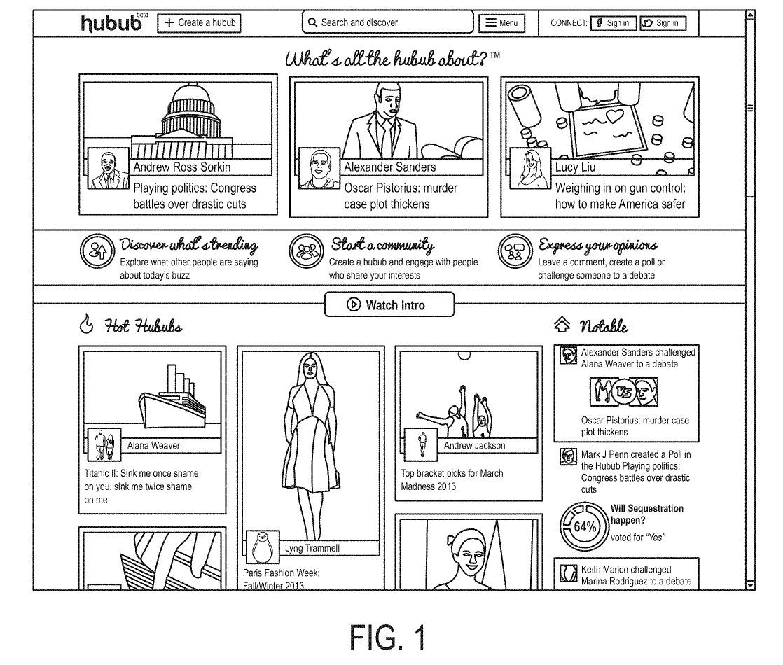

This disclosure will first describe interactive discussion engines of the type with which the present third-party site integration inventions can be used, and then describe the present invention under the heading “Third Party Site Integration” below. FIG. 1 shows a user interface for a login screen in accordance with an embodiment of the system. As with each of the user interface screens discussed below, the interface is served by a web server device and accessible to users over a network via a web browser on the user's client device, which may be an end user computer, tablet, smart phone, or other device capable of running a browser that receives and presents content and a user interface from a server. The content and user interface may be in the form of one or more HTML, XML, and/or other browser displayable files along with accompanying graphic and video content files.

As is illustrated in FIG. 1, users can sign in to the system via a social media provider of which they are a member. Examples of such social media providers include, e.g., FaceBook, Twitter, Google+, and the like. The function of providing sign in functionality through a social media provider may be performed in whole or in part by an app that is written for a particular provider, e.g., a FaceBook app, or may be performed in whole or in part by one or more web-connected servers. In alternative embodiments, sign in may be provided without interaction with a social media site.

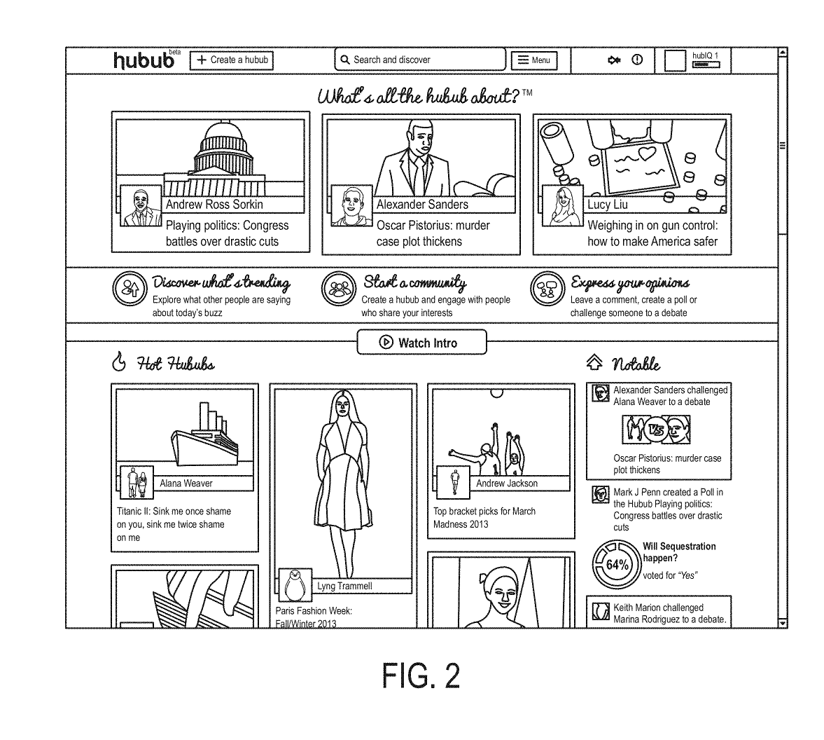

FIG. 2 shows a graphical user interface illustrating an initial screen following login in accordance with an embodiment of the invention. The initial screen can include, e.g., trending discussions, news items, polls, debates/challenges, etc., along with the associated controls and other user interface elements. The user interface can be generic, particularly for newly registered users, or customized for the particular user that has logged in. Shown in the initial screen of FIG. 2 is a “Create a Hubub” pushbutton control which initiates a topic creation process illustrated in the following figures.

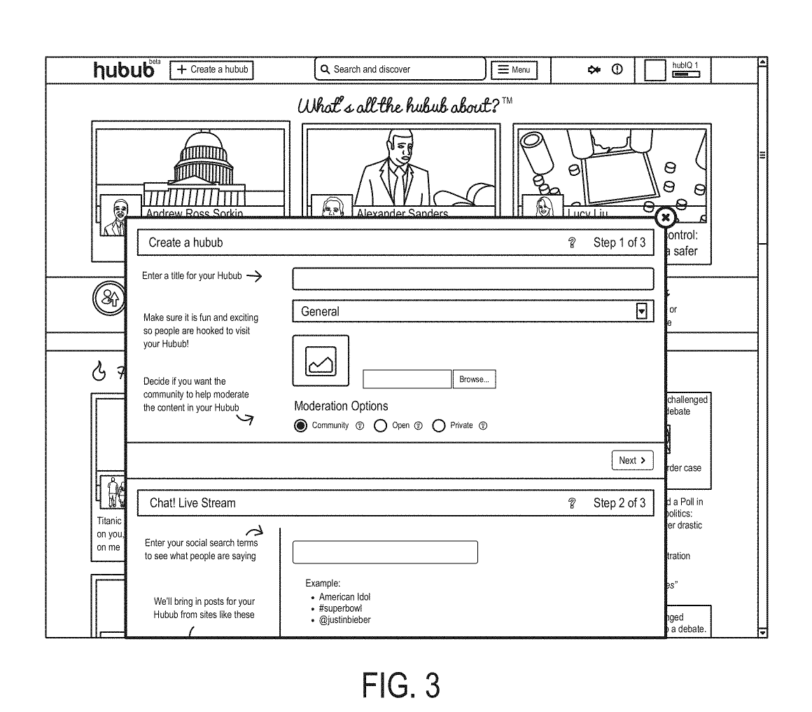

FIG. 3 shows a graphical user interface illustrating a topic creation screen in accordance with an embodiment of the invention. This screen is triggered by the “Create a Hubub” pushbutton discussed above, and prompts a user to input a new topic for publication. Any topic of interest can be used as input to the system of the invention. In addition to the topic, the system may optionally prompt a user to select a category for the topic. Non-limiting examples of such categories include General, News, Legal and Crime, Politics and Government, Science and Environment, Sports, NHL, NFL, MLB, Olympics, NBA, Finance, Business and Economy, Personal Finance, Entertainment, TV, Movies, Music, Gaming, Celebrity, Living, Beauty and Fashion, Dating and Relationships, Health and Fitness, Parenting, Food, Tech, Smartphone, Tablet, Internet, Autos, Buying and Selling, Repairs and Maintenance, Travel, Destination, and Vacation Planning. The available categories may be static or may be dynamically selected by the system in accordance with trending topics.

With continued reference to FIG. 3, when the new topic is created, the user is given three choices as to how posts on the pages he or she is creating will be moderated and made available to the public. Non-limiting examples of these choices are: Community, Open, and Private. When the “Community” option is checked, community members may assist in approving posts before each post is publicly displayed. In this respect, a community is a social network of users who are registered in the system. A community can be topic-based, i.e., it can include only those who have subscribed to a particular topic, or it can be a wider community that includes, for example, all users who have registered with the system. When the “Open” option is checked, all posts are immediately viewable by the public. When the “Private” option is checked, all posts are sent to the creator of the topic for approval before the post is posted on the topic page. The Private option may further be configured to keep posts completely private such that members of the public cannot search for posts, and the posts are available to the poster and members of his social network or sub-network only. For example, such completely private option may be used to create a topic that is viewable only to members of a “class project” social network. As is further shown in FIG. 3, the topic creation screen may include a control that allows a user to upload an image associated with the topic chosen. Such control is shown as a “Browse” button on FIG. 3.

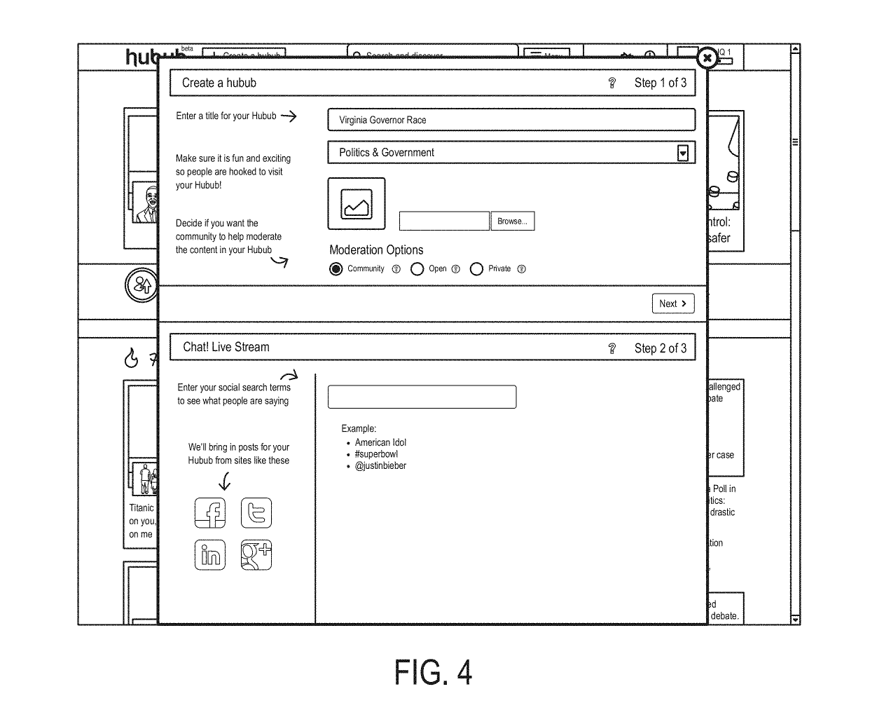

FIG. 4 shows the graphical user interface of FIG. 3 with a topic having been entered by the user and a category for the topic having been selected. Activating the “Next Step” pushbutton control in FIG. 4 causes the system to conduct a backend search of web sites, RSS feeds, twitter feeds, social networking feeds, and other internet-accessible sources for content that is pertinent to the selected topic. Such content includes, e.g., videos, articles, tweets, and photos. The search engine may maintain and use its own database for the search, and/or may interface with third party search engines. The search logic may be configured to use the category chosen in the topic creation screen of FIG. 3 to improve the relevance of the search results.

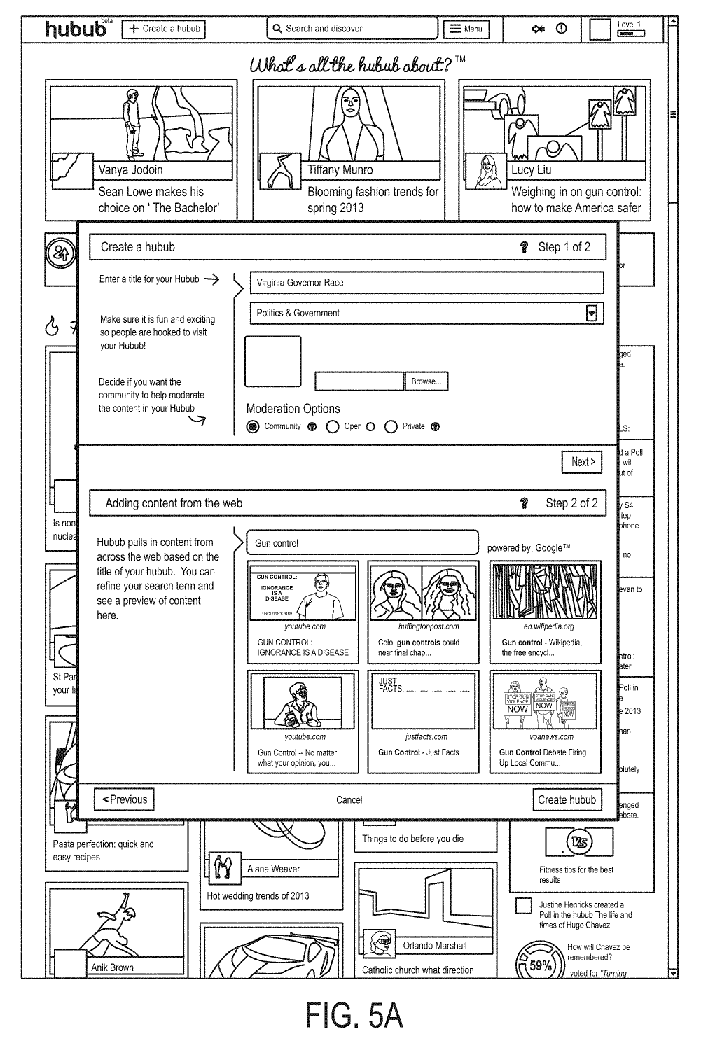

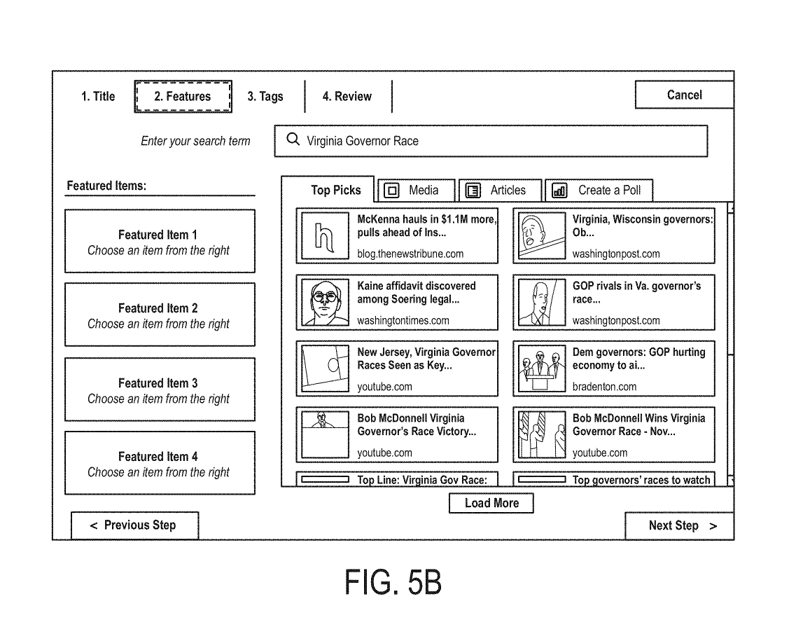

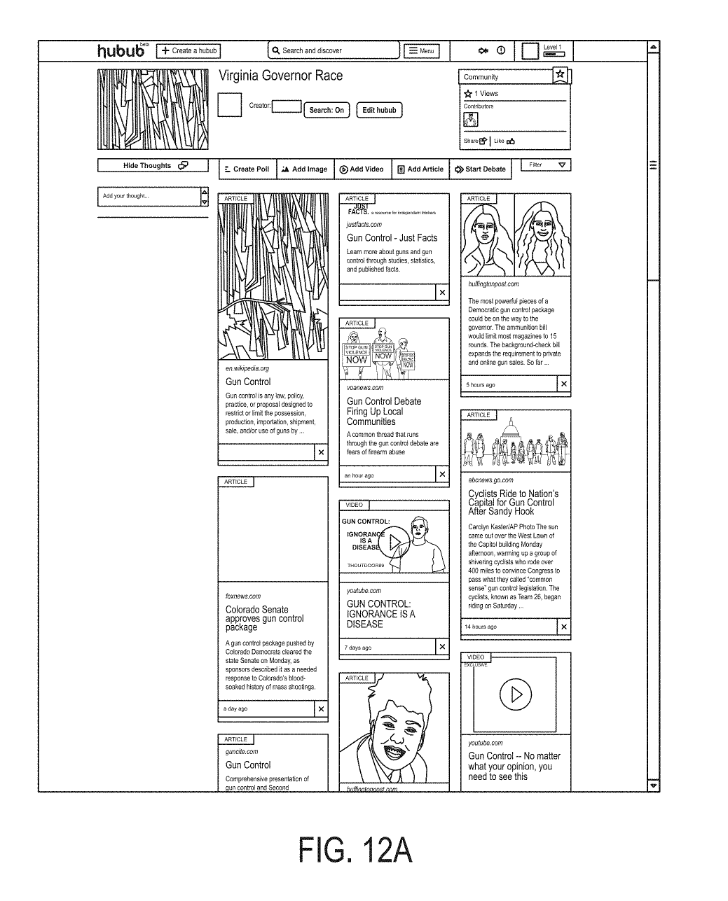

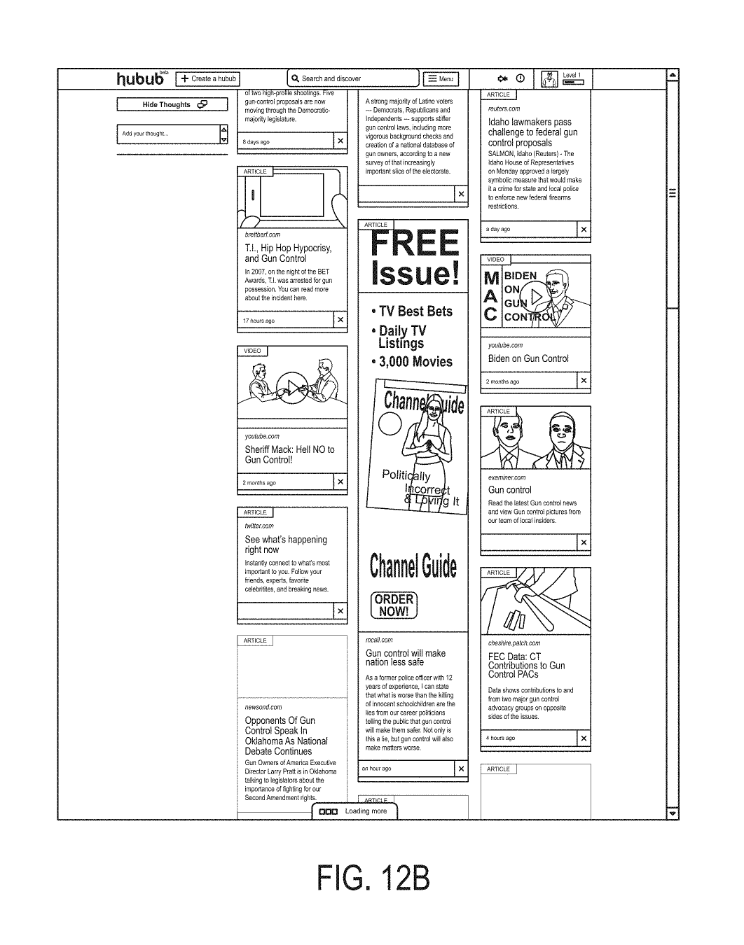

FIG. 5A shows a refinement page that is the result of clicking on the “next” button in FIG. 4. This page allows a user to enter search terms that, in addition to the topic title and topic category, will be used by the system to search for content with which to populate the topic page being created. In this screen, the user can enter such additional search terms and see a preview of content relating to the topic title, category, and additional search terms. Such content is a preview of the initial content that will be provided on the user's published topic page. While the user types in search terms, the system according to the invention searches for content either within the system or elsewhere on the internet, or both, and returns the preview content in real time. If the user changes the search terms in this screen, the content preview also changes in real time. In this respect, the user can change the search terms that are being used until he or she is satisfied that the right content will result, and then click on the “Create hubub” button to create a published topic page. Doing so brings the user to the screen shown in FIGS. 12A and 12B.

FIGS. 5B though 11 illustrate an alternative method for getting from the topic creation screen of FIG. 4 to the published topic page of FIGS. 12A and 12B. That is, FIGS. 5B through 11 are an alternative to the refinement screen of FIG. 5A. In these figures, a manual process requiring substantial user interaction is used to set up a search that will be used by the system to populate a published topic page, whereas such process is largely performed automatically by the system in the embodiment of FIG. 5A. FIG. 5B shows a graphical user interface illustrating a topic feature selection screen, which is the next step in the topic creation process once the initial search has been conducted. Thumbnail images and headline type descriptions representing items resulting from the search are shown on the right hand side of the screen. The user can select from these search results the items that the user desires to be featured on their published topic page. The selection may be performed by means of a “select” button that appears when the user hovers over an item in the search results on the right, or may be performed by other known selection means such as a drag-and-drop interface, radio buttons, check boxes, or the like. Tabs may be provided for user selection of the manner in which the system displays search results in the present screen. For example, selection of the “Top Picks” tab displays only those search results that have been elevated to a certain predetermined level of popularity. Likewise, selection of the “Media” tab limits the search results displayed to those that are media, and selection of the “Articles” tab limits the search results displayed to those that are articles. A “Create a Poll” tab may be provided to allow the user to create a poll to be included in their published topic page. The poll creation process is discussed further below.

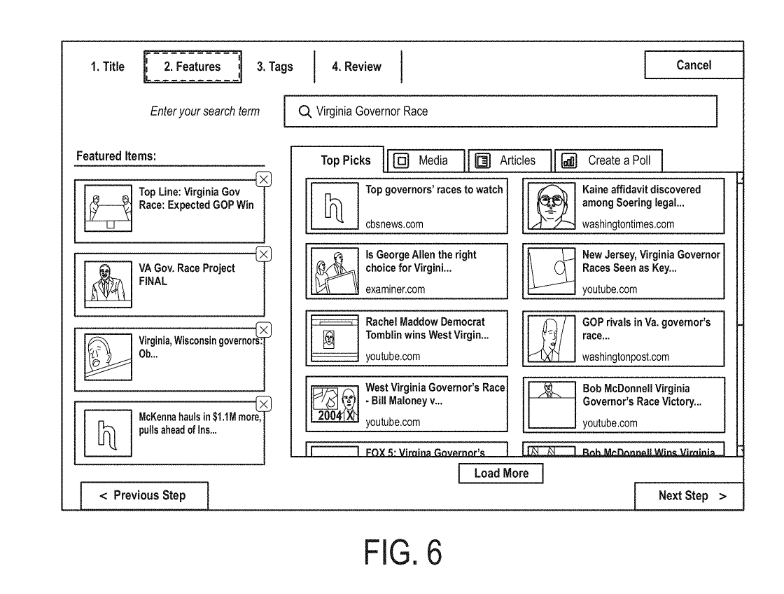

FIG. 6 shows the user interface of FIG. 5B with four featured items having been selected and showing in the left hand column.

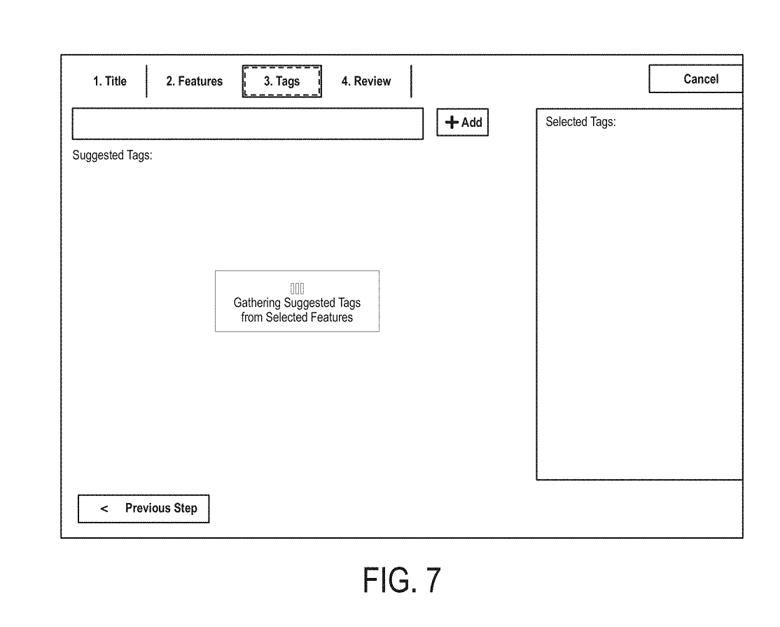

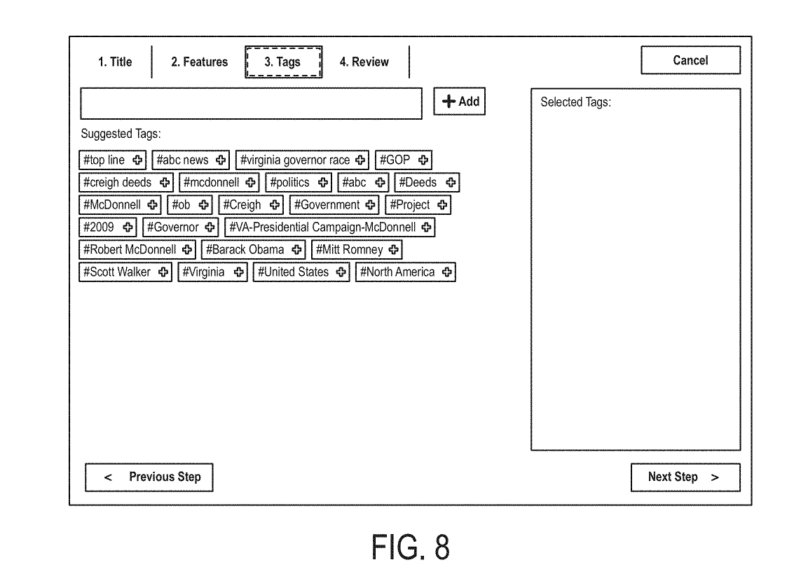

Once the user has selected the items to be featured in their published topic page via the user interface shown in FIGS. 5 and 6 and selects the “Next Step” pushbutton control, the system gathers hash tags associated with the selected feature items. See FIG. 7. The system then displays hash tags to the user as is shown in FIG. 8.

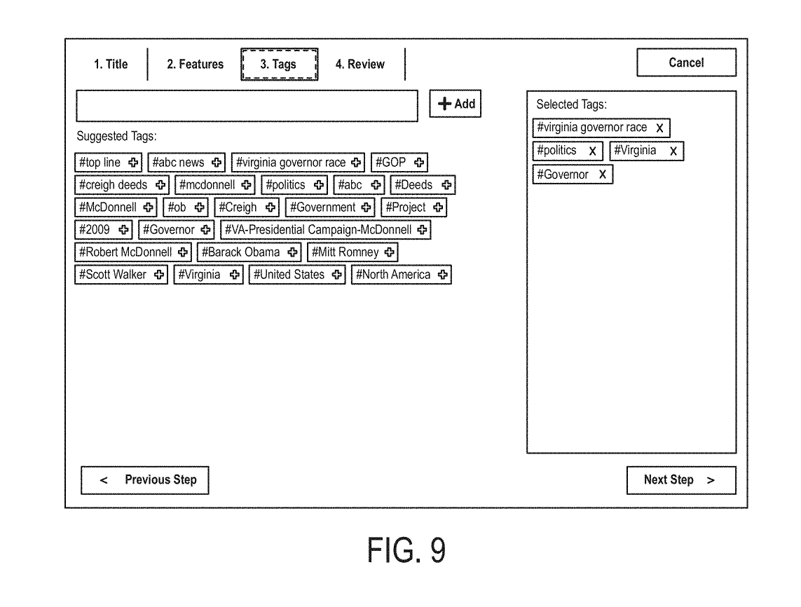

The user interface shown in FIG. 8 allows the user to select from the hash tags associated with their featured items those hash tags that are to be associated with their published topic page. The user may choose those hash tags that are the best fit for his particular topic and/or those hash tags that are more likely to drive desired traffic to his published topic page. When the topic page is published, the selected hash tags can be published as metadata associated with the page, fed to search engines, fed to social networking sites, fed to news sites, or otherwise distributed with a reference to the published topic page, such as a URL at which the page can be found. FIG. 9 shows the user interface as in FIG. 8 with pertinent hash tags having been selected by the user in the right hand column of the screen. A “Next Step” pushbutton control is provided for advancing to a topic review screen once the user has finalized their selection of hash tags.

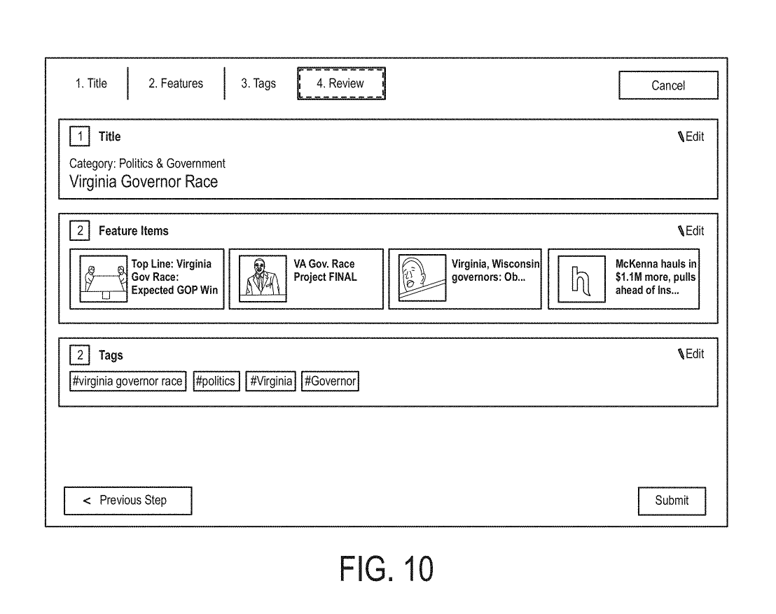

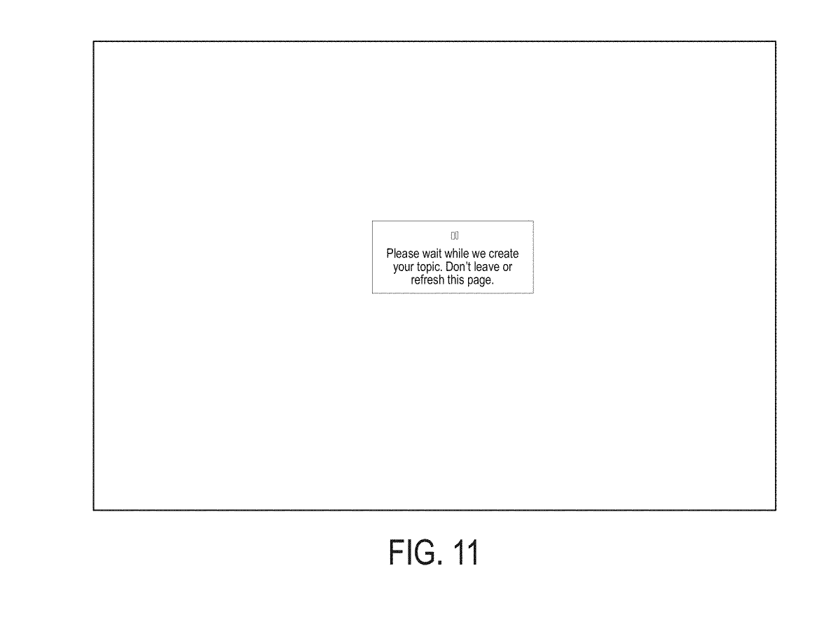

FIG. 10 shows a graphical user interface illustrating a topic review screen in accordance with an embodiment of the invention. The screen displays a summary of the title, featured items, hash tags to be utilized in building and populating the user's published topic page. Once the user has reviewed and approves of the summary information, he may select the “Submit” button to cause the system to create the page. FIG. 11 shows a “Wait” screen that may appear once the “Submit” button has been activated.

FIGS. 12A and 12B show the top and bottom, respectively, of a topic page that has been published and made accessible to the user that created the page, all users in a community such as a social network, and/or all users on the internet. The content on the published topic page relates to the topic and category entered by the user in FIG. 4, refined by the search terms entered and edited in real time on FIG. 5. The page may include both static and interactive content, including videos, articles, tweets, photos, poll results, a poll creation interface, a status line where a user can add his thought to the page, an “Add Image” tab that allows a user to add a photo or other graphical content to the published topic page, an “Add Video” tab that allows a user to add a video to the published topic page, and an “Add Article” tab that allows a user to add an article to the published topic page. The published topic page may include the image uploaded by the user via the topic creation user interface shown in FIG. 3. Once a topic page has been published, the user can then add his opinion, ask the community to vote on questions, perform administrative tasks associated with managing the topic, or perform any function provided to other users visiting the page.

The published topic page is dynamic and changes over time as users interact and as new items associated with the topic, category, and selected search terms (or the selected hash tags in the alternative embodiment) become available from other sources on the internet. In this respect, the system of the invention can be configured to continuously or regularly conduct a search of internet-accessible sites using the topic, category, and search terms (or the selected hash tags in the alternative embodiment) associated with items appearing on the page initially and over time, and add new items to the page that is published as they are discovered in such ongoing search. For example, twitter feeds can be monitored by the system and tweets matching the topic/category/search terms (or selected hash tags) can be re-posted to the published topic page. As shown at the top of FIG. 12A, a toggling “Search On”/“Search Off” pushbutton control can be provided to allow the user to select whether the dynamic updating feature is turned on or not.

As illustrated in FIG. 12A, a “Create A Topic” pushbutton control may be provided on the published topic page. Activation of this pushbutton control allows any user viewing the page to create a new topic or subtopic related to the current topic page using the same or a similar process as is described above with reference to FIGS. 3-12B.

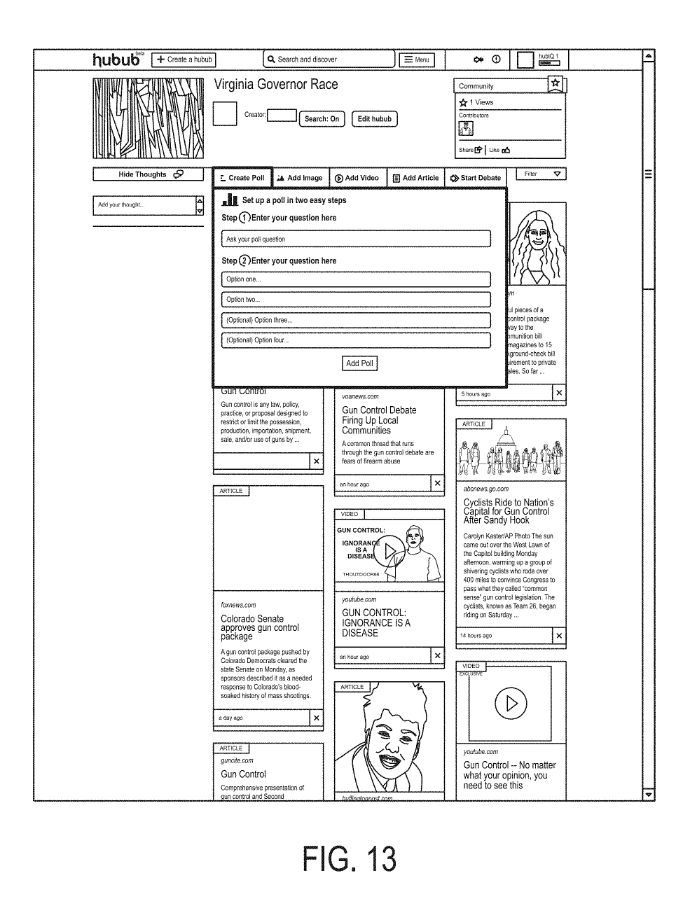

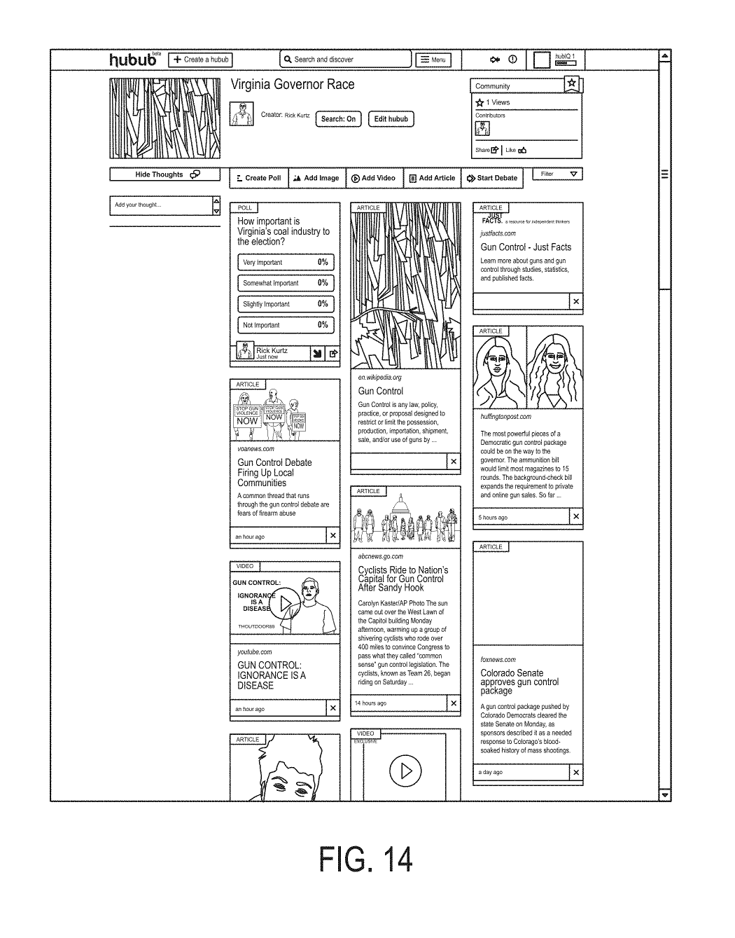

FIG. 13 shows a graphical user interface illustrating a poll creation portion of a published topic page in accordance with an embodiment of the invention. Upon selecting a “Create Poll” tab on the published topic page, fields appear on the page that allow a user to enter a poll question, add an image to be associated with the poll, add options for answering the poll, and any other information that is useful for creating a poll. FIG. 13 shows the published topic page with the “Create Poll” tab selected and the fields thereunder having been filled in by a user. In this example, the user enters a poll question “How important is Virginia's coal industry to the election?” and has entered the options “Very important,” “Somewhat important,” “Slightly important” and “Not important.” Once the fields are completed and the “Create” pushbutton control is selected by the user, the system creates and inserts the poll into the published topic page. FIG. 14 shows a graphical user interface illustrating a poll portion of a published topic page in accordance with an embodiment of the invention.

In syndication embodiments, the system of the invention is programmed and otherwise configured to provide brokering services between content providers desiring to expeditiously publish photos, videos and other copyrighted works and third party publishers or news agencies. For example, a user who has taken a photo or video depicting a breaking news event can use the system to publish such photo or video and specify or agree to terms of a license grant that the user is willing to accept for access to or re-publication of the work by third parties. The system can be configured to charge such third parties accordingly for access or republication rights in the work, or to grant a license to such third parties under terms specified by or agreed to by the user who has uploaded the work.

In a further embodiment, the system is programmed and otherwise configured to interact with a social networking site, such as FaceBook, Twitter or Google+. For example, the system may be configured to publish to a user's wall on a social networking site, utilize a user's list of friends, followers, or other associates in distributing content, and send notifications through such social networking sites. These functions may be performed in whole or in part by an app that is written for a particular provider, e.g., a FaceBook app, or may be performed in whole or in part by one or more web-connected servers.

A level tracking system, designated herein as “HubIQ”, can be provided to track all activity on the website of the invention to give users a credibility score (“IQ score”). Since users want to be known as being intelligent, the IQ score creates the right motivating factor for users to play clean and intelligently. Site moderation can be conducted automatically with user support via voting in this regard. The invention can interrelate content and scores to community voting on the content. For example, if a user submits content and it becomes popular, the user is awarded points. However if the user submits content that results in review, the following happens:
i) the content remains on the website of the invention but a flag will present stating under review;
ii) a notice will go to participants on the topic and then to the community to vote on the content under review;
iii) the notice will show up in an invited judges message stream;
iv) if they chose to participate, they will read a warning that says the content maybe offensive and they will earn hubIQ points (our new game mechanic label);
v) if the majority of the judges agree this should be removed. it will be kicked. judges will be tracked on decisions that the majority agreed with or disagreed with in the hubIQ;
vi) the poster will get a notice that his material has been reviewed and removed and that will be tracked in the hubIQ;
vii) the poster will then have a chance to appeal by clicking the appeal button. If he does so, the process repeats but with new judges;
viii) if it survives review, then the post will have a verified label.

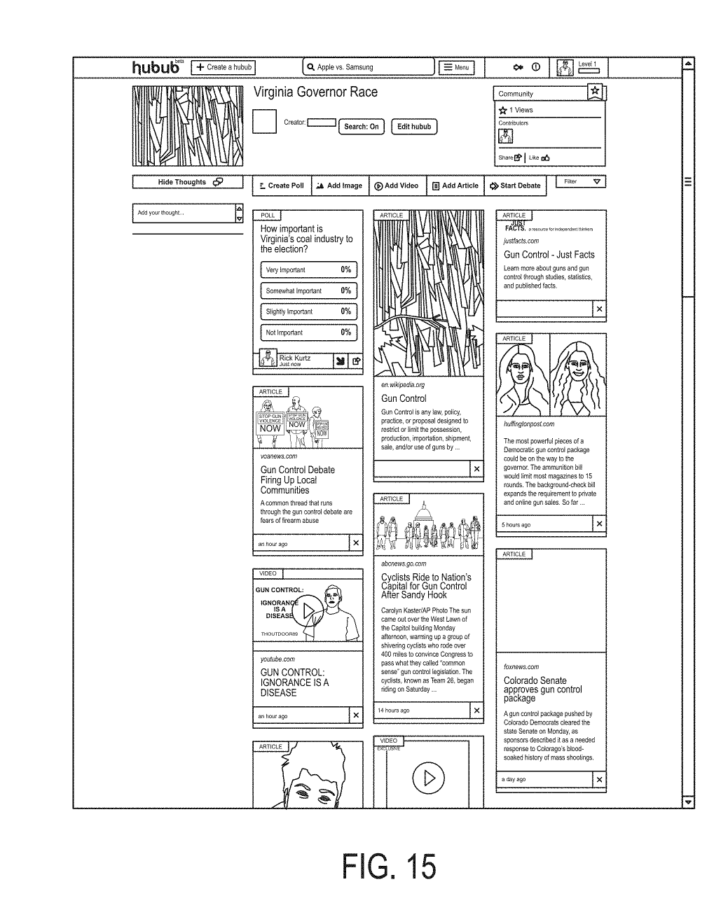

Voting on a particular post, poll, or other content can be limited to a particular community within the system or may be available to other larger communities (or, in one embodiment, even members of the public). With respect to step ii) above, the system can be configured such that if the number of persons voting on a particular post or other content is insufficient, i.e., below a certain threshold number of votes, the post or other content can be displayed to a wider community for voting. FIGS. 15-18 illustrate a social-search embodiment of the invention. In this embodiment, a search engine is provided and is configured to search for any topic. The system provides a user with the ability to add content to the results of their searches so that subsequent searches by that user and/or other users show that content in the search results. Non-limiting examples of content that can be added include images, videos, articles, and/or polls.

FIG. 15 illustrates a home page in accordance with the social-search embodiment. A search bar is provided on the page, e.g., at the top of the page. A user can enter search terms into the search bar and, as the user types the search terms, the system can display a drop-down list of topics that changes in real time or near real time as search terms are entered. In the example shown in FIG. 15, the search terms are “Apple vs Samsung.” The system is configured to display images beside existing topics, i.e., topics for which a topic page has already been created by any user or topics which have already been searched by any user. The user conducting the search can select an existing topic from the drop down list or, alternatively, create a new topic by hitting “enter” or selecting the topic that has a placeholder “h” image beside it.

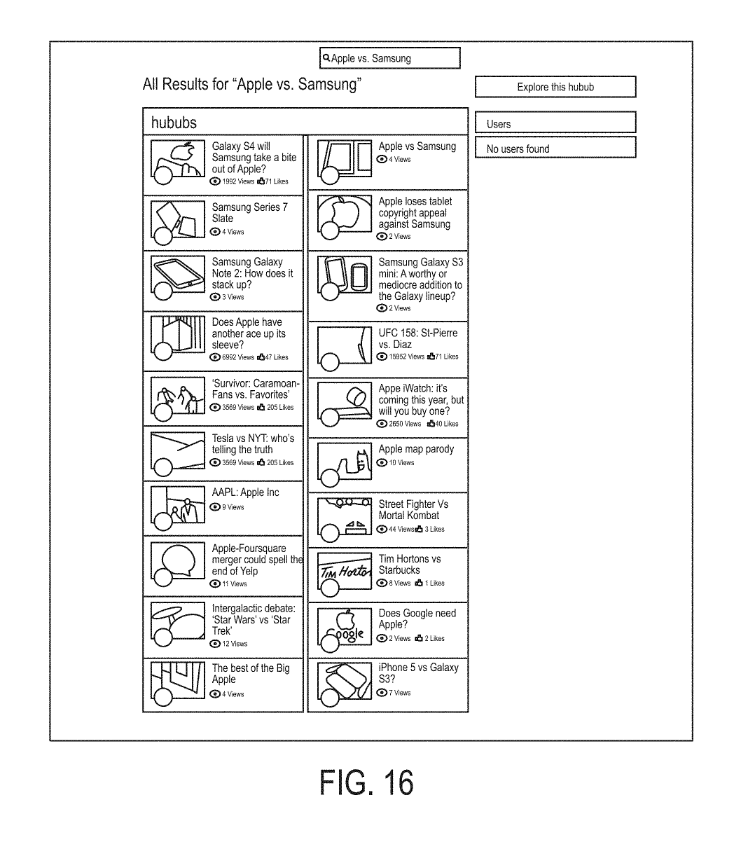

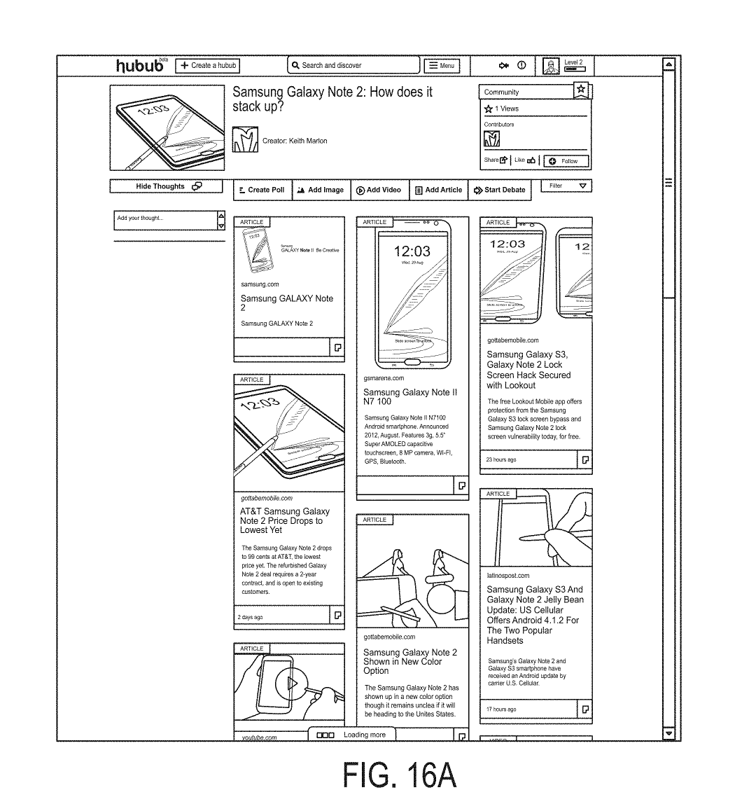

FIG. 16 shows an initial results page for the “Apple vs. Samsung” search. This screen displays a set of thumbnails representing articles and other content that the search engine identified as pertaining to the search entered by the user. The interface of FIG. 16 allows a user to select a one or more thumbnails upon which the final search results page will be based. In displaying the search results, the system may provide higher priority to displaying articles that have been commercially sponsored. For example, a pest control company may provide funds or other form of consideration in exchange for bringing articles containing expert advice written by their staff up to the top of the search results page when a user enters the search term “termites.” In this respect, the system may be configured to receive an article uploaded by a commercial user which has paid consideration and to automatically match such uploaded articles to topics and/or search terms that are relevant so that the article can be floated to the top of the search results page and/or can appear on topic pages that are relevant. In this manner, the system can provide highly targeted advertising in a manner that is desirable to the target customer.

FIG. 16A shows a final search results page that is displayed after the user selects a thumbnail in the screen of FIG. 16. The format of the search results page may be similar to the format of the topic pages discussed above with reference to FIGS. 12A and 12B, and the functionality associated therewith may be provided. An “Explore this hubub” pushbutton control may be provided to allows the user to create a topic from the search results page, in much the same manner as is described above with reference to FIGS. 2-12B. The search engine of the present invention can be configured to further limit the search results to content within the present system. The engine may also be configured to display to the user on the initial or final search results page, or the published topic page, prospective deals that the user may be interested in based upon the search terms, topic name and category selected by the user. For example, if the user enters the term “termites” in the search bar or during the process of creating a new published topic page, the system may display on the search results page a local deal by which the user can receive a pest treatment for a discounted rate. In this manner, the commercial user is provided with the ability to present deals to a user who is already interested in a topic that is relevant to their product or service.

As shown in FIG. 16A, the user is provided with an interface on the search results screen which allows him or her to add an image to the search results, add a video to the search results, add an article to the search results, and add a poll to the search results. Other forms of content may also be added to the search results. In this respect, the system can be configured such that, after such content is added to the search results, subsequent searches for the term or terms entered by the user will result in the building of a page that includes the content added by the user. A process for adding an image to the search results is described below, and the process may operate in a similar manner with respect to the addition of videos, articles, and any other content to the search results. Videos, articles, and other content may be added simply by pasting a URL in the text box shown next to the “Choose” button shown in FIG. 16. Alternatively, a browser plugin may be provided to allow a user to add content from any page on the internet via a button that is displayed on the user's browser regardless of the site that is being visited. The function that allows a user to add a poll to the search results operates in much the same manner as is discussed above with reference to FIGS. 13 and 14.

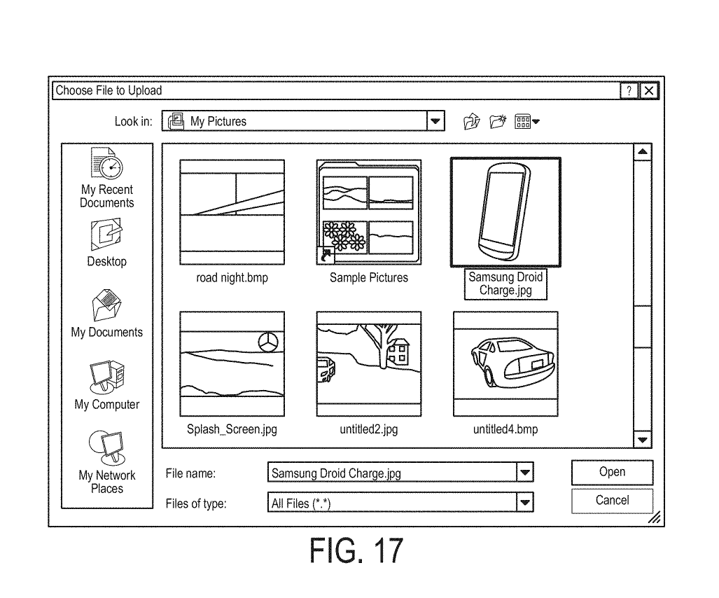

FIG. 17 shows an example of a dialog box that is displayed when a user selects the “Choose” button under the “Add Image” tab in FIG. 16. The dialog box allows the user to select a local graphics file for uploading to the system of the invention.

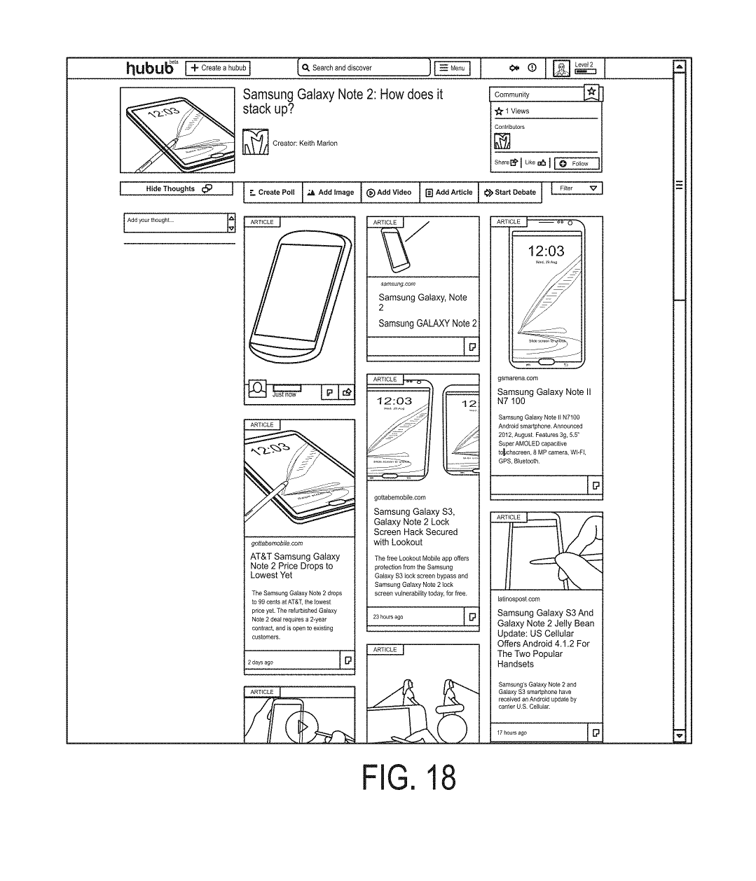

FIG. 18 shows an example of a search results page after the user has uploaded an image in accordance with the procedure described above. The uploaded image is displayed in the search results. The system is configured such that future searches for the terms “Apple vs Samsung” or related terms, by the user or any other user, will include the image uploaded by the user. The system handles other content, such as videos, articles, and polls, that were added by the user in a similar manner, displaying them in the search results page. Thus, the social-search embodiment provides a very powerful means for users to contribute content to search results that they think best fits, thereby leveraging a network of human brains in making a determination that particular content should be included in search results for a particular set of terms and/or related terms. By providing a social search function that allows humans who have an affinity for a topic to correlate the semantics between content and a topic of search, the invention can provide a dynamic system that improves search results over time.

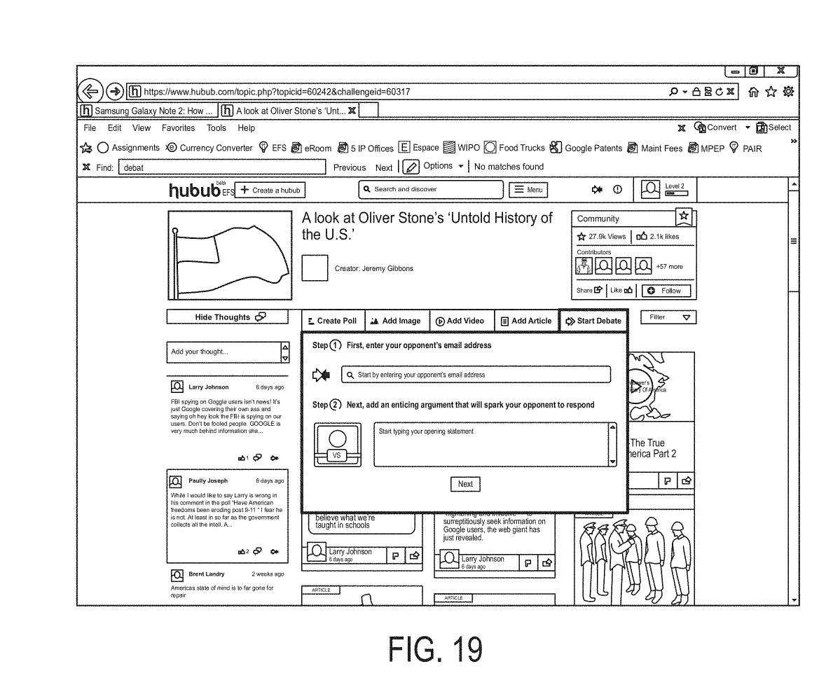

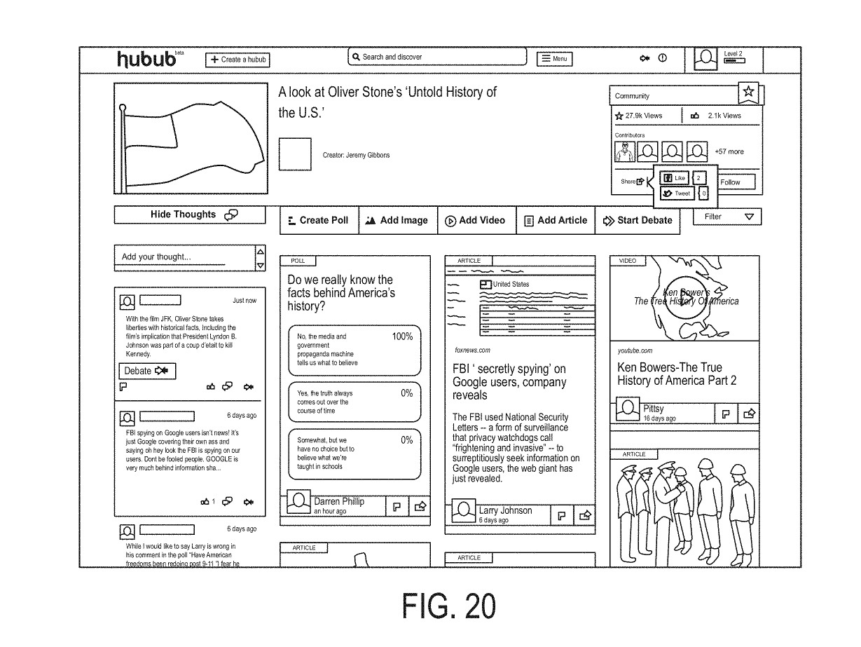

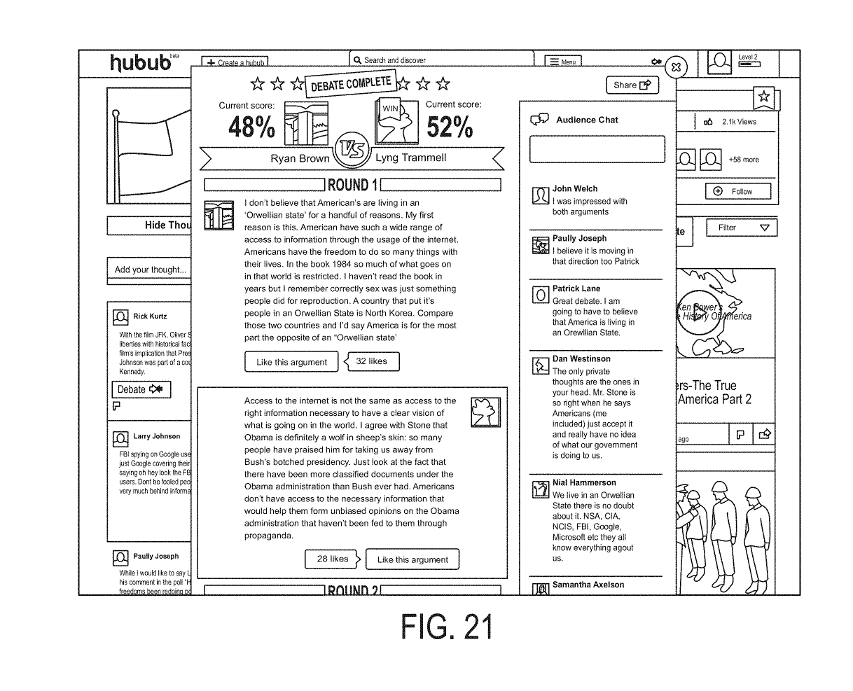

As shown at the top of FIG. 18, for example, published topic pages and other pages in the system can be provided with a “Start Debate’ pushbutton control. FIGS. 19-21 illustrate the process that is initiated by activation of the Start Debate control. Such pushbutton control may also be displayed in association with a particular comment within a comment stream such as that shown in the lefthand column of FIG. 21. As shown in FIG. 19, a dialog box is displayed requesting input from the initiating user as to the identification (e.g., email address or user name) of the opposing user that the initiating user wishes to challenge to a debate. This dialog box also includes a field for entering an enticing argument that will spark the opponent to respond. Clicking the “Next” button causes a notification to be sent to the proposed opponent via email, text, a notification within an app, or other notification means, advising the opponent that he has been challenged to a debate. Such notification may also include the text of the argument of that was entered by the initiating user, along with a link to the debate and/or an “accept” link. The opponent can then proceed to post an opposing comment. As is shown in FIG. 20, the comments of the initiator and those of any opponent accepting the challenge are shown in the left-hand column of a topic page or other page. Below each comment, the system provides the ability for users to give each comment an up or down vote. The system can be configured to tally the up and down votes at a predetermined interval, e.g., 24 hours after the challenge was accepted, to determine and display the winner of the debate. FIG. 21 shows an example of a screen notifying users of the winner of a debate. The winner of the debate may also be awarded points in accordance with the point system discussed above.

The system can be configured to allow a team of users to use the system to create a new work such as a school project. In this respect, the system can be configured to allow team members to collaborate and build a topic page, essay, article or blog around a topic. With respect to essays, articles and blogs, the system may be configured to operate through a third-party API to provide the ability to create a particularly formatted article or other end product. Of course, the system may also be configured to call its own API to allow users to author a particularly formatted article or other content.

In accordance with an embodiment of the disclosed invention, any data generated as a result of user interaction with the system may be mined and sold for market research purposes. For example, the hash tags that users have associated with topics may be used to gain insight into the types particular information sources that a user with an affinity for that topic prefers.

Technologies used to implement the invention may include, for example, the following:

OSS

Apache—http://httpd.apache.org/
The core web server platform

PHP—http://www.php.net
The core development platform

Mysql—http://www.mysql.com/
Main database infrastructure

twitter php—www.twitter.com
Back end twitter communications (auth)

facebook php—www.facebook.com
Back end facebook communications (auth)

UserInfUser—http://code.google.com/p/userinfuser/&&www.cloudcaptive.com
Gamification API

Google search—www.google.com
Search services and dynamic content

Bing search
Search services and dynamic content

twitter js—www.twitter.com
Client side twitter communications (search)

facebook js—www.facebook.com
Client side facebook communications (search)

jquery—http://jquery.com/
Main client development platform

knockout.js—http://knockoutjs.com/
Client side UI data binding

masonry—http://masonry.desandro.com/
Mosaic dynamic layout

swipejs—http://swipejs.com/
Swipe actions for all touch based browsers

excanvas—http://excanvas.sourceforge.net/
HTML5 canvas for internet explorer

google analytics—analytics.google.com
core analytics

ajaxmanager—http://www.protofunc.com/scripts/jquery/ajaxManager/
web service call distributor and debouncer

jqplot—http://www.jqplot.com/
html5 graphing/charting

google webfont—https://fonts.googleapis.com
improved fonts for web pages

phpboing—http://code.google.com/p/phpboing/
IOC container for push server

php-annotations—http://code.google.com/p/php-annotations/
Annotation processing for the IOC container

log4php—http://logging.apache.org/log4php/
flexible scalable logging

socketdaemon—http://code.google.com/p/phpsocketdaemon/
high performance socket framework for php

Commercial
AWS—Amazon web services—all production infrastructure including web servers, databases, caches and load balancers
Cloudflare—scalable dns service
Edgecast—Content delivery network
Web Purify—profanity removal
addthis—share support for social media

In an embodiment, the invention provides a system useful in serving web pages that integrate an online digital content service with a publication and interactive discussion engine so as to provide a single outlet for publication of multiple forms of content originating with the artist. In such embodiment, the system may include a data store containing data for populating a front end interface and a series of specific artist pages and a server operatively coupled to the data store. The system is programmed such that, in response to activation of a URL by a first visitor, the front end interface is served over a computer network such as the internet to a computing device under control of the first visitor. The front end interface includes a series of links to the series of corresponding artist pages. In response to activation of one of the links to a particular artist page by the first visitor, the system serves a specific artist page. The specific artist page is configured to display first digital content selected by the specific artist, the digital content being directed to at least one topic. The artist page further includes interactive element for provoking participation of a plurality of users regarding the a topic and the content. The artist page further includes a radio interface configured to control playback of music of the specific artist. In response to participation of a user, the system automatically creates an updated specific artist page by updating the specific artist page with second digital content provided by the user, the second digital content being directed to the topic. In response to activation of one of the links to a particular artist page by a second visitor, the system serves the updated specific artist page. In an embodiment, the interactive element comprises a video representation wherein the artist can be asked a question from at least one of the plurality of users and provide an answer via a video response. The system may be configured to syndicate the video response by making a license to the video response available to third parties.

In an embodiment, the invention provides a system useful in serving web pages that integrates an activity column with a publication and interactive discussion engine so as to provide targeted content delivery. The system includes a data store containing data for populating a front end interface and a plurality of specific topic pages, and a computer system comprising at least one server operatively coupled to the data store. The computer system is programmed to, in response to activation of a URL by a first visitor, serve the front end interface over a computer network to a computing device under control of the first visitor. The front end interface includes a plurality of links to the plurality of corresponding topic pages. In response to activation of one of the links to a particular topic page by the first visitor, the system serves a specific topic page. The specific topic page is configured to display a first digital content selected by a first user, the digital content being directed to at least one topic. The specific topic page is further configured to display interactive means for provoking participation of a plurality of users regarding the at least one topic and the content. The system displays an activity stream that provides a live list of user activity, the list of user activity comprising a plurality of activities selected by the system as relating to a topic or microtopic that the first visitor is following. In response to participation of at least one of the plurality of users, the system automatically creates an updated specific topic page by updating the specific topic page with second digital content provided by the at least one user, the second digital content being directed to the topic. In response to activation of one of the links to a particular topic page by a second visitor, the system serves the updated specific topic page.

In an embodiment, the invention provides a system useful in serving web pages that provide a publication and interactive discussion engine in a manner that provides targeted content delivery solely by matching brands to content. The system includes a data store containing data for populating a front end interface and a plurality of specific topic pages, and a computer system having at least one server operatively coupled to the data store. The computer system is programmed to, in response to activation of a URL by a first visitor, serve the front end interface over a computer network to a computing device under control of the first visitor, the front end interface including a plurality of links to the plurality of corresponding topic pages. In response to activation of one of the links to a particular topic page by the first visitor, the system serves a specific topic page. The specific topic page is configured to display first digital content selected by a first user, the digital content being directed to at least one topic. The topic page includes interactive means for provoking participation of a plurality of users regarding the at least one topic and the content. The system tracks, from the server side only, topics that the first visitor has viewed. In response to participation of at least one of the plurality of users, the system automatically creates an updated specific topic page by updating the specific topic page with second digital content provided by the at least one user, the second digital content being directed to the topic, and updating the specific topic page with user content or advertising relating to brands associated with the topics that the first visitor has viewed. The system then serves the updated specific topic page.

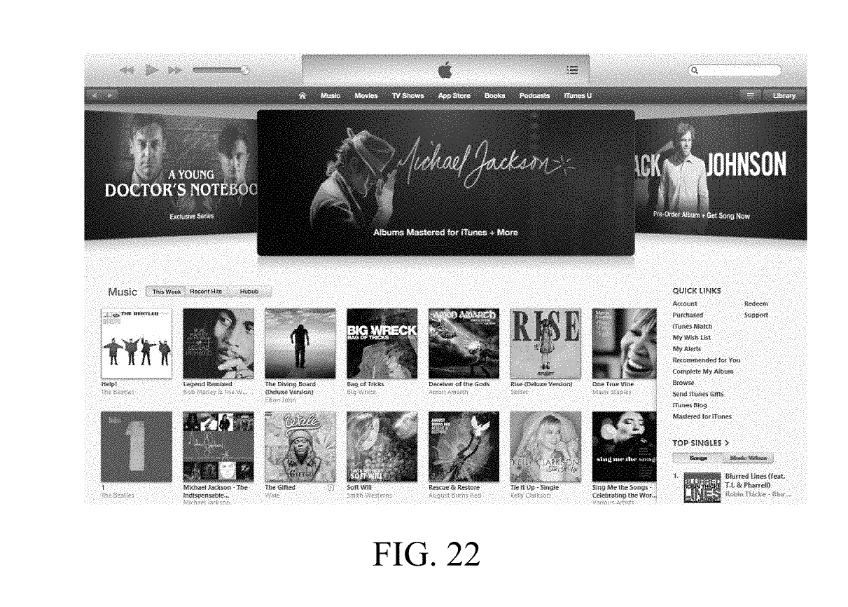

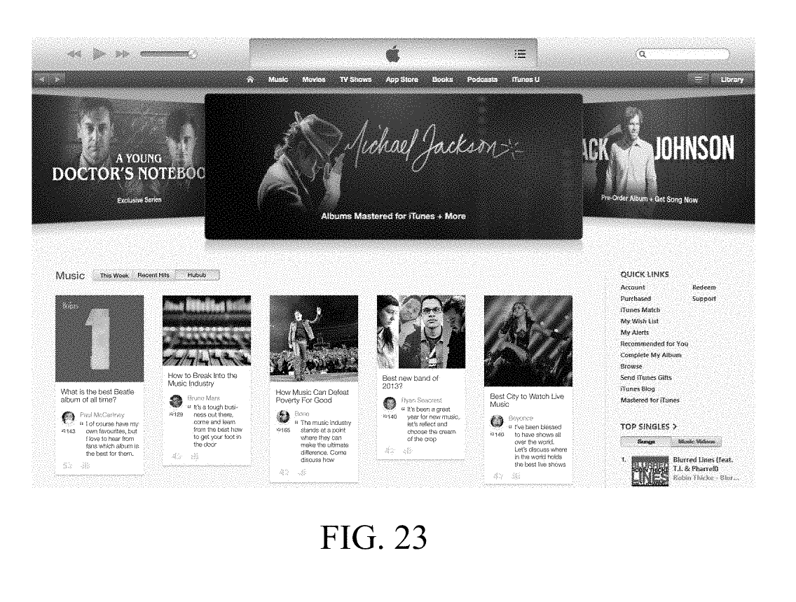

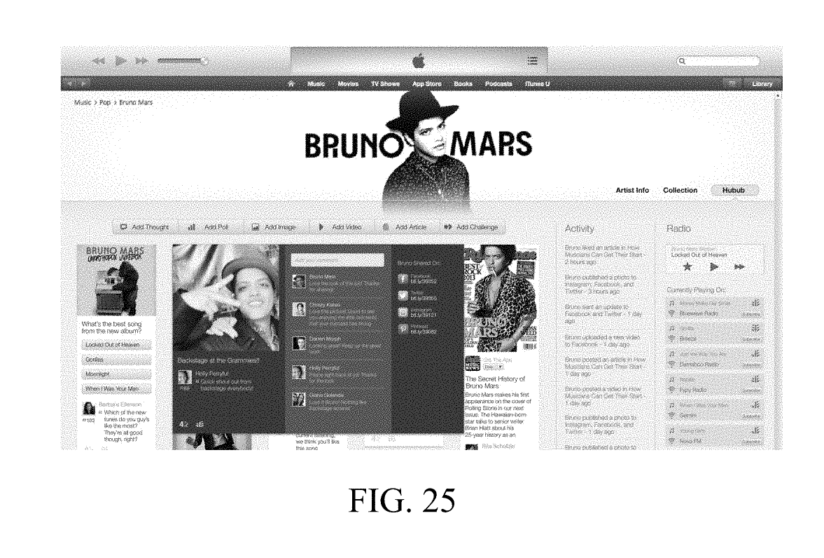

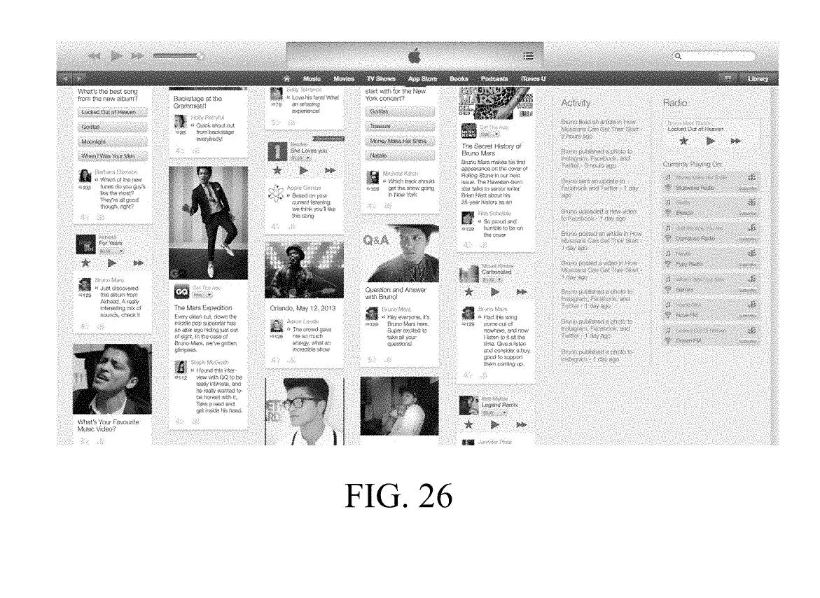

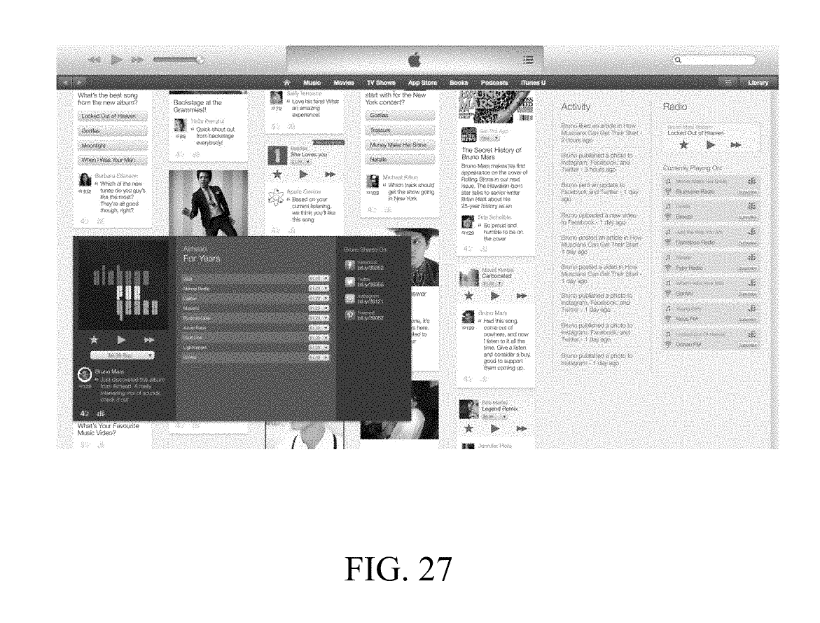

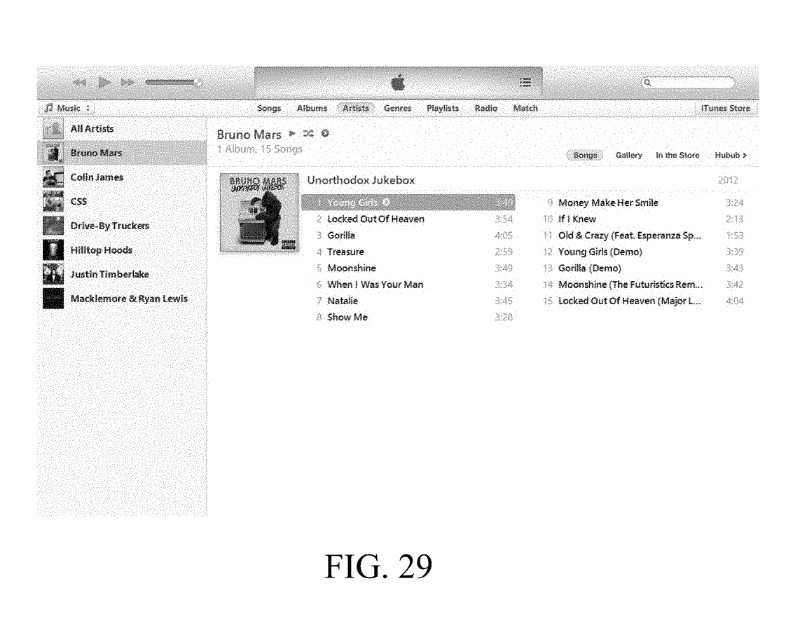

FIGS. 22-29 show examples of pages generated by a system that integrates a publication and interactive discussion engine as described above with an online digital content service. FIGS. 22 and 23 show examples of a front end interface for an online digital content service. Such services include any online service for providing digital audio or video content, such as an internet radio service provider or the like. All aspects and functionality described above regarding the disclosed publication and interactive discussion engine can be integrated with an online digital content delivery service in accordance with the present invention. The system generates a front end interface that includes a plurality of links to a corresponding plurality of specific artist pages, and serves the front end interface to the user in response to the user requesting a particular URL in a web browser. In the interface shown in FIGS. 22 and 23, the user is presented with links to a plurality of specific artist pages. Selecting one of the links causes the web server to serve a specific artist page.

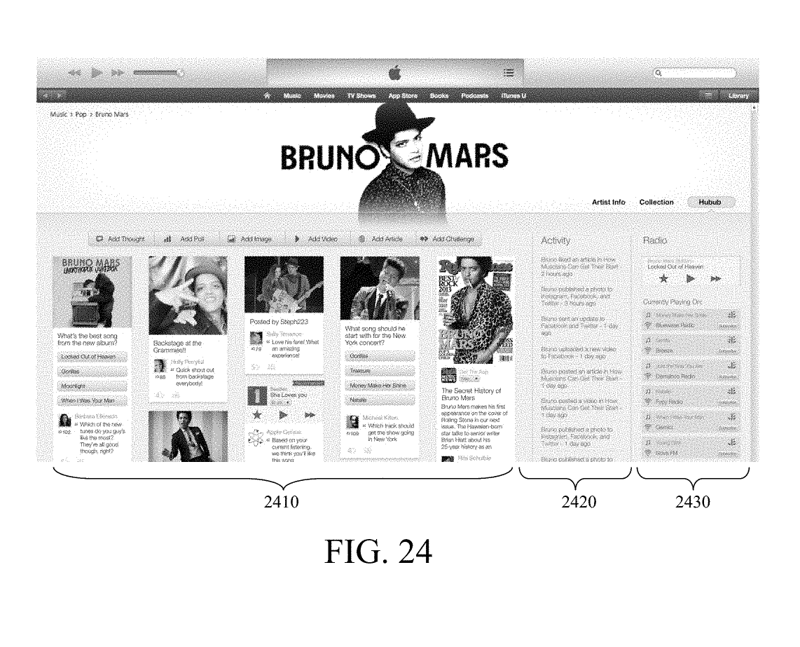

FIGS. 24-28 show examples of specific artist pages generated by the integrated publication/discussion engine and online digital content service. The system provides pages such as those shown for each of a plurality of artists whose digital content is available via the service, e.g., those artists whose music is played on an internet radio service. The integrated system allows the individual artist to publish content to his or her fans via his or her artist page, and allows interactive discussion and other activity among the artist and the fans.

As illustrated in the artist page shown in FIG. 24, for example, the page may contain a live town hall section 2410, an activity stream 2420, and a radio interface section 2430. The live town hall section 2410 provides a place for the artist, fans or others to publish interactive content concerning the artist, subjects of the artist's choice, or the like. The system can be configured so that the artist is provided with control over the content that appears in the live town hall section 2410. The live town hall section 2410 may provide a means for publishing articles, images, videos, tweets, polls, and challenges in much the same manner as is described above with respect to published topic pages. The system may be configured to allow an artist to repost to his or her artist page a post that was made in a separate social media site or source, such as Twitter, Facebook, Hubub.com, RSS feeds, Instagram and online forums, or to repost to his or her artist page an article that was published on a separate news site such as Yahoo!, Spin, NPR, MTV, and the like. In this respect, the invention provides a portal for all of an artist's content, regardless of where online it originated.

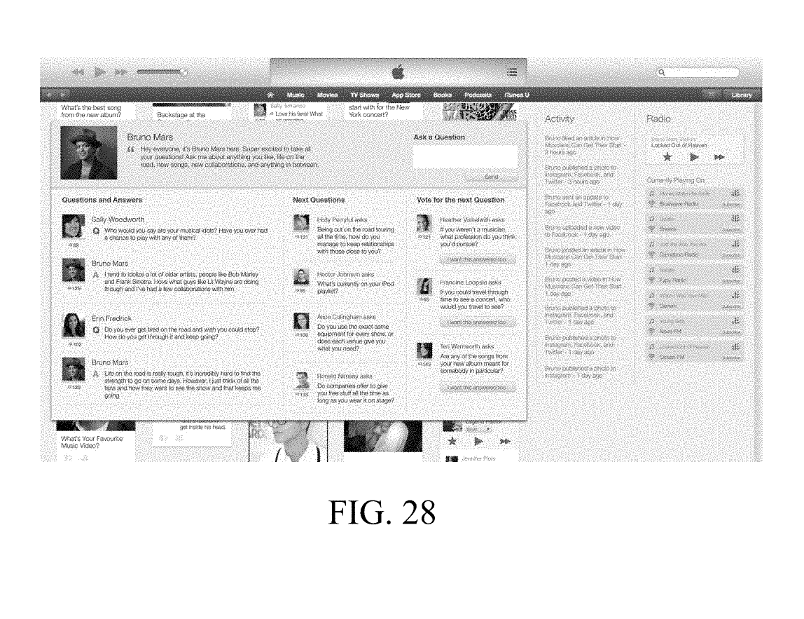

The system can be configured to allow the artist to use the live town hall section 2410 to pose questions to his or her fans and post answers from such fans, as is illustrated in FIG. 28, for example. In this respect, the system can be further configured to pose a question posted by the artist to a random set of users, or all users, who are currently viewing the artist page containing the live town hall section 2410, and to post such users' responses or a subset thereof selected by the artist. The live town hall section 2410 may also be used to vote on a particular topic or question posed by the artist, and to rate a post of an artist or other user. The system can be configured to tally such voting or rating, and display the results thereof in the live town hall section adjacent to the content that has been voted upon or rated. The system can be configured to provide automated curation and filtering of content posted to the live town hall section 2410. The system may select for display in the live town hall section 2410 or on a home screen content concerning the hottest trending topics and/or content which has been deemed by the system to be interesting to a particular user or set of users. In this respect, content on a particular topic may be deemed interesting if, for example, there is a high level of activity on the system concerning the topic and the content is high quality.

The activity stream section 2420 on the artist page provides a live list of the artist's activity within the site and/or on other social media sites.

The radio interface section 2430 provides controls for playing streaming content such as an internet radio station. The radio interface is not limited to internet radio, but could provide a player for music or video content selected by the user. The system may be configured such that the radio interface section 2430 or other portion of the artist page interfaces with a recommendation engine, such as Apple's Genius recommendation engine, to recommend music or other content to the user. The system may also provide a means for users to control the selection of songs or other content played by the internet radio station via a poll that is posted on the artist's page.

Thus, the invention can provide, via the artist page, a single place for the artist to publish all of their content. In this respect, the live town hall section 2410 can be a single publishing tool. Indeed, the publication and interactive discussion engine of the invention can be integrated into any media publisher's site to add a single publishing tool for authors, artists, musicians and other content creators to publish their work in all forms.

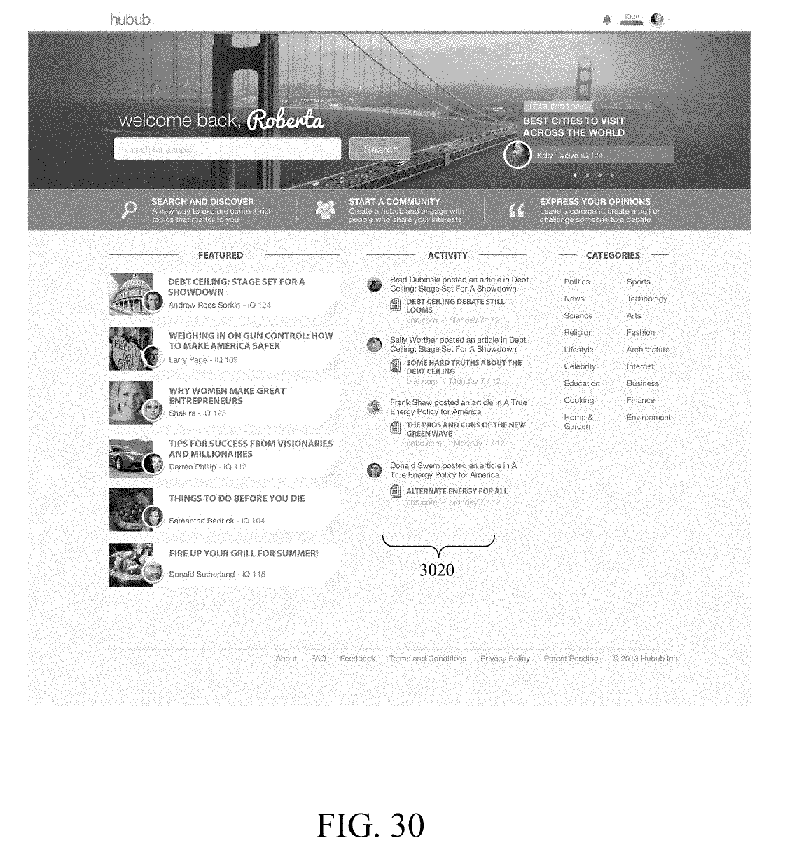

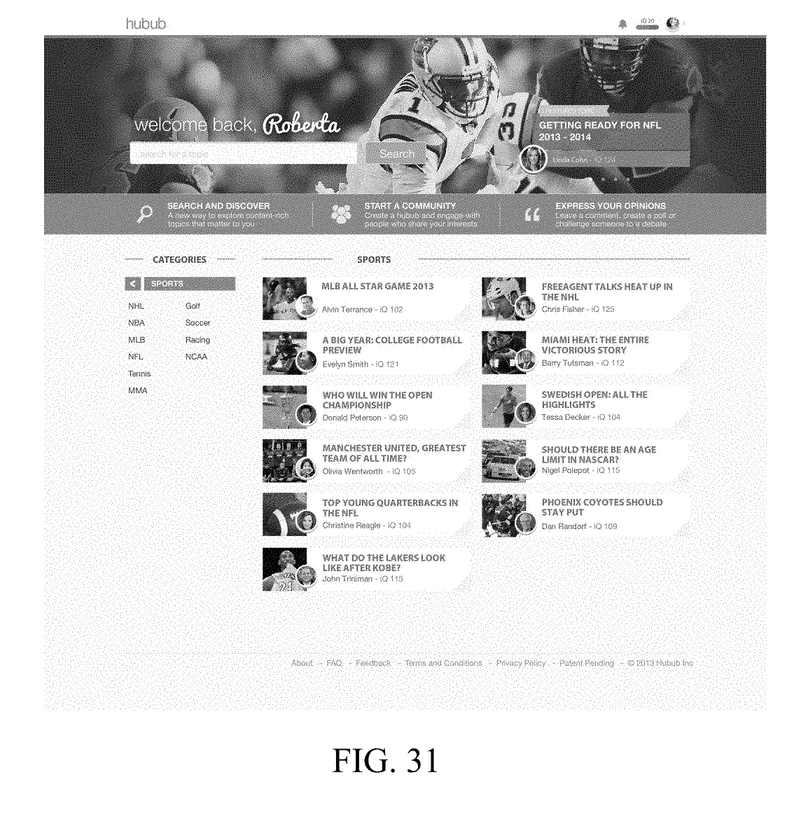

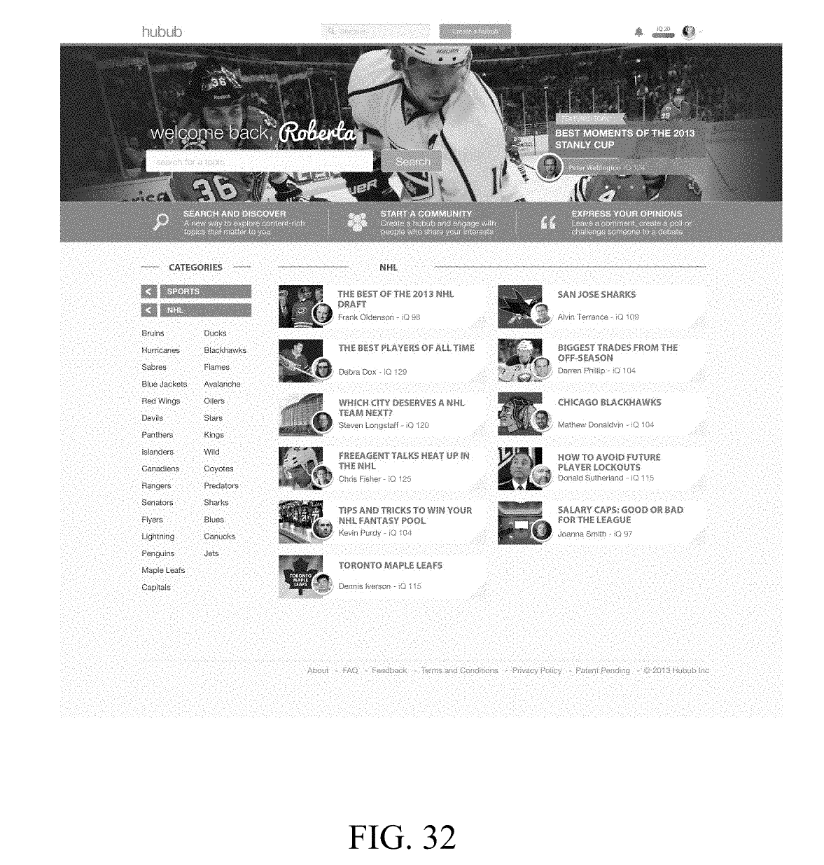

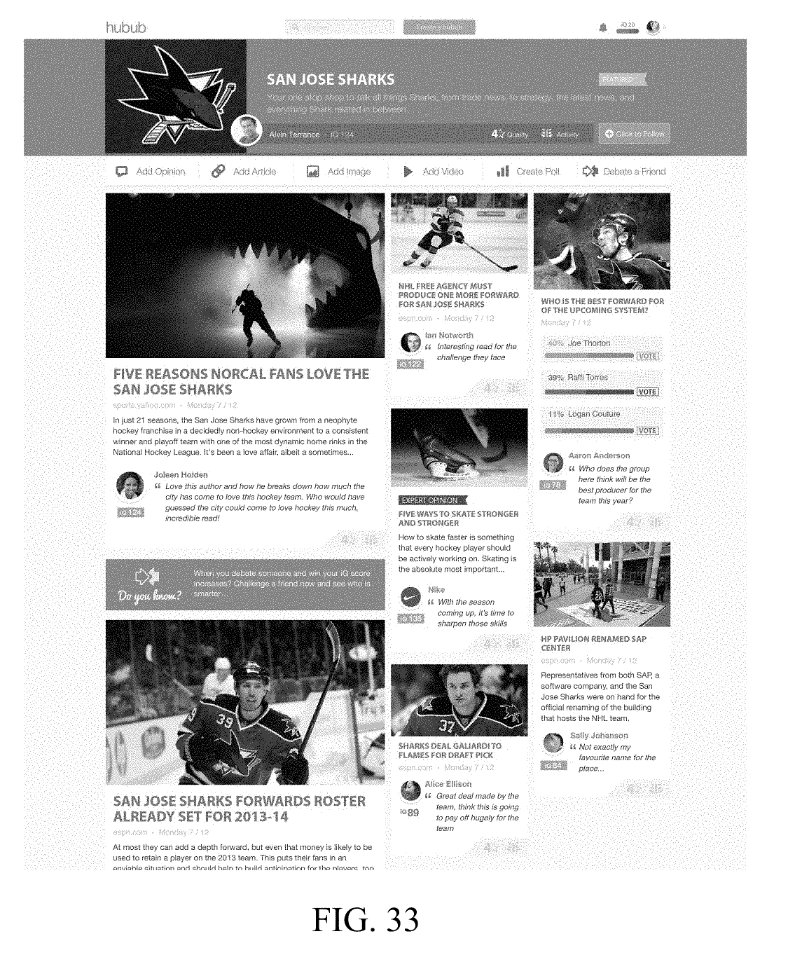

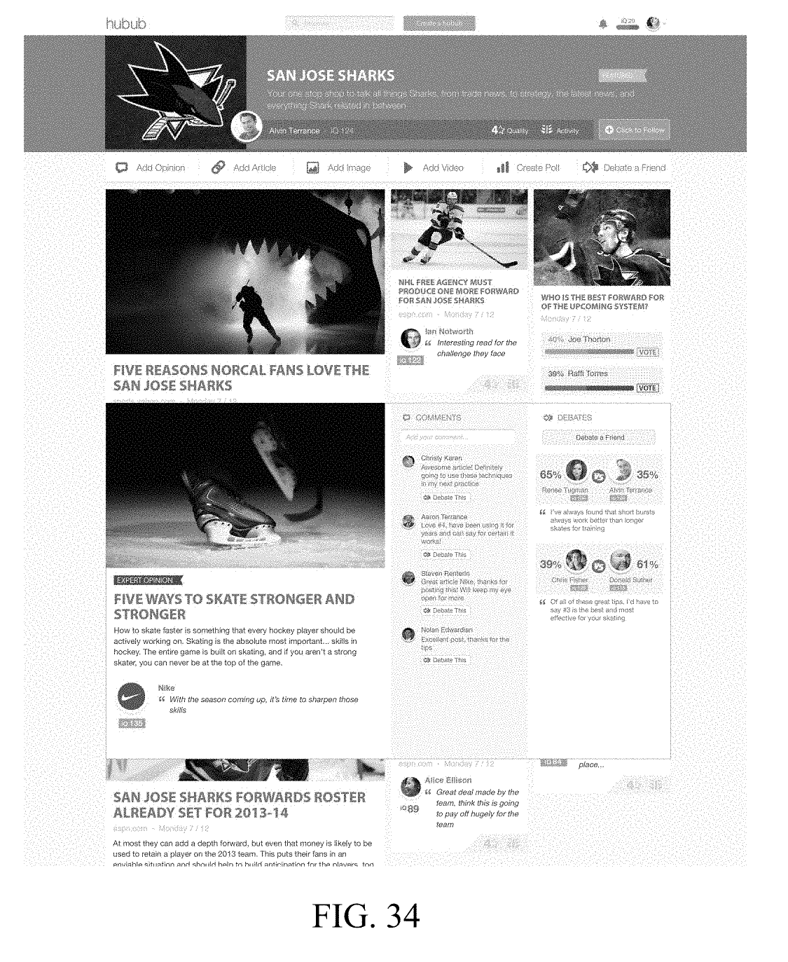

FIGS. 30-34 show examples of pages generated by a publication and interactive discussion engine in accordance with another embodiment of the invention. As shown in FIG. 30, for example, an activity column 3020 provides a list of recent activity on the site and/or on separate social media or news sites. The system may be configured to provide targeted content delivery via the activity column For example, if a user is following a particular topic or microtopic within the site, the user will see activity concerning such topic or microtopic in the activity column. The system further provides the ability for a user to share content on the system to a separate social networking site or source, such as FaceBook or Twitter. As shown in FIGS. 33 and 34, an “Add Opinion” control is provided to allow a user to add a blog to a published topic page.

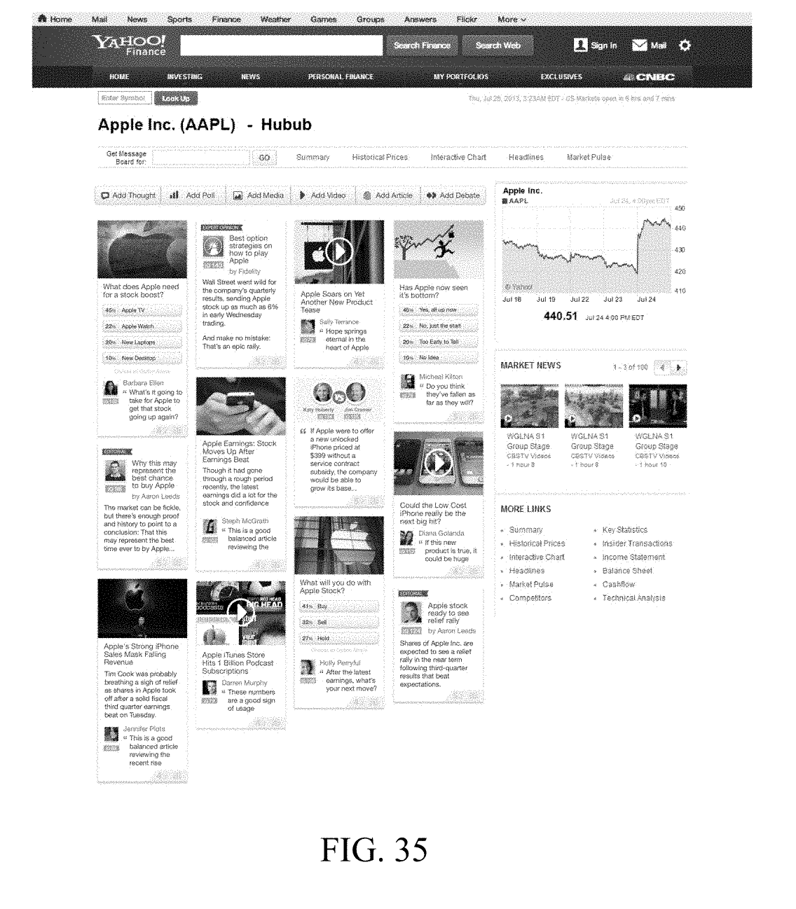

FIG. 35 shows an example of a page generated by a system that integrates a publication and interactive discussion engine with a financial information site.

In an embodiment, the system is further configured to provide targeted advertising to users in a fully non-intrusive manner that respects the user's privacy. Such functionality is provided without the use of cookies, spyware, or other software installed on the end-user's device. Rather, the system is configured to provide targeted advertising solely by matching brands to content. The system is configured to track, from the server side only, the topics that a user has viewed and to serve to that user content and/or advertising relating to brands associated with those topics. The invention may further be provided with a localization feature whereby the system tracks the geographic area where the user resides and recommends stores or events in such area. For example, if the system determines that a particular user is an avid follower of cycling, the system may display advertising for one or multiple cycling or athletic apparel stores in the user's geographic area. The system may also display to such user a list of events relating to cycling in his geographic area. In this respect, the system may further provide an interface for an event coordinator to upload events to the system, and an interface for a merchant to upload specials, coupons, or current advertising to the system.

In an embodiment, the disclosed system provides a platform for collaborative, topic-based communities that:
Evolves search by leveraging the social web. People (not just algorithms) organically refine search results as a natural outcome of their participation;
Improves targeted marketing, since topics, not users, are the focal point of communities;
Improves the way news is consumed by combining the best articles, images and videos from across the Web with the best user-generated content;
Eliminates or substantially reduces privacy concerns by ending the dependency on personal information for social commerce. Hubub offers users an honest social contract since targeting is based on topics not user behavior;
Implements a new permission-based social commerce platform (marketplace) matching users and products around topics of interest;
Offers the first elegant, multimedia replacement for the commenting stack within third-party media properties.

Each of the points above will now be discussed in further detail. In an embodiment, the disclosed system and method evolves search by leveraging the social web. People, not just algorithms, organically refine search results as a natural outcome of their participation. Firstly, many companies have tried to leverage user behavior to make search better because the human brain arguably has a superior ability to relate the right content to a topic. Such companies generally failed because they were encouraging an unnatural behavior that that did not provide value to the users. Secondly, that dynamic changes, however, when you create a topic with an active community. In the natural course of users sharing what they know and referencing materials that they believe are compelling, they are indexing the web.

In an embodiment, the disclosed system and method improves targeted marketing, since topics, not users, are the focal point of communities. When users actively engage on a topic, you know exactly what those users are interested in, there is no need to analyze behavior to draw inferences. Furthermore, banner ads no longer work. There only is a small (e.g., 0.01%) chance that someone is going to click on them. Both users and brands dislike banner ads, but heretofore there has been no good alternative. Topics create a natural environment for high-quality native advertising. An example of this is the topic of building a deck: a brand that sells home improvement goods would likely be interested in providing a well-articulated, expert piece of advice to that user group. Such “sponsortorials” are an advantageous means to provide expert content from the brands knowledgeable about a topic.

The disclosed system and method, in an embodiment, improves the way news is consumed by combining the best articles, images and videos from across the Web with the best user generated content. Traditional news reporting is biased because each news distribution channel is beholden to their owners. In addition to media outlets, there has been an explosion in user-generated content, both written and visual. Distribution for user-generated content has primarily occurred via blogs and niche sites, where there is a low probability of discovery. The central flaw in these forums is that there is very little cross-discovery of content. For example, users are not likely to search for what a particular other user thinks about the fiscal cliff. However, that flaw is resolved by the presently disclosed system, which provides functionality to allow the other user to publish or post into a specific forum on that topic. Furthermore, as users publish their views, vote, debate and associate other content they believe is relevant to a given issue, the presently disclosed system democratizes the consumption of information on the web. Finally, the presently disclosed system and method can be used to reshape the distribution of news by combining the best of media generated content with the best of user-generated content to create one of the purest sources of news and information on the web.

In an embodiment, the disclosed system and method eliminates or substantially reduces privacy concerns by ending the dependency on personal information for social commerce. The system can be configured to offer users an honest social contract since targeting is based on topics and not user behavior. In this respect, broken contracts abound throughout the Internet. That reality is changing and, the more it changes, the more users become vulnerable to a disruptive alternative. Furthermore, the invasion of user privacy on the Internet is growing more acute and, consequently, user awareness and anxiety is growing. The invasion of privacy is designed to target better banner ads that just don't work. The presently disclosed system and method addresses this by matching the brand to the topic, which is also the most precise type of targeted marketing on the web today. Further, when users submit anything to most popular websites, they lose ownership of their content. In an embodiment of the presently disclosed system and method, legal ownership of user-generated content stays with the user who posted it; if there is external demand for that content, the user has the rights to syndicate that content on the presently disclosed website marketplace and allow media companies or other entities to purchase or license it. The disclosed system and method can also be configured to provide users with freedom from banner ads. As stated earlier, banner ads are universally disliked and simply are not effective. As most social media sites cling to this failed concept, it opens the door to companies that can redesign the user experience so banner ads are unnecessary. The presently disclosed system and method can be configured to enable a positive, constructive and desired relationship between users and brands by matching brand expertise to the right topics.

The disclosed system and method, in an embodiment, can implement a new permission-based social commerce platform (marketplace) matching users and products. In this respect, in the context of the foregoing, the system can leverage the concept of a marketplace. Whereas deal-of-the-day websites must expend significant energy to acquire both users and brands, the presently disclosed system and method at scale can match brands with users at a time when users are most interested in their products and services. In an embodiment, the system does not allow explicit advertising on topic pages. If brands want to explicitly promote a product or service, and the user is interested in such promotions, the system can provide a button which takes users into a topic-specific marketplace. With respect to the marketplace, users can sell or license their popular or in-demand content to third parties, while charging a transaction fee.

The system may be configured to provide the first elegant, multimedia replacement for the commenting stack within third-party media properties. In this respect, media companies face three major issues. Firstly, most conversation about their content is happening on sites other than their own, so they cannot monetize effectively. Poorly implemented commenting stacks are insufficient to create engagement around an issue. Media companies can wrap content with the presently disclosed collaboration tools to keep the conversation on site and direct traffic from other forums back to their sites to gain new users. Secondly, for the reason mention above, the disclosed tools enable a more practical and effective means of monetizing content. The third major issue is publishing tools. Media companies and brands are having a difficult time posting and managing their content across the social web. In an embodiment, the presently disclosed system and method acts as a publishing tool for their content to all their social media pages. Media companies, brands and personalities currently have different content posted across the social web, but do not have a single source or repository of that content. For example, today, a high-profile corporate or government entity needs to search multiple social media sites to access and catalog all their content. By acting as an integrated source for publishing across the social web, the disclosed system and method solves this problem.

### Sponsored Content System and Method

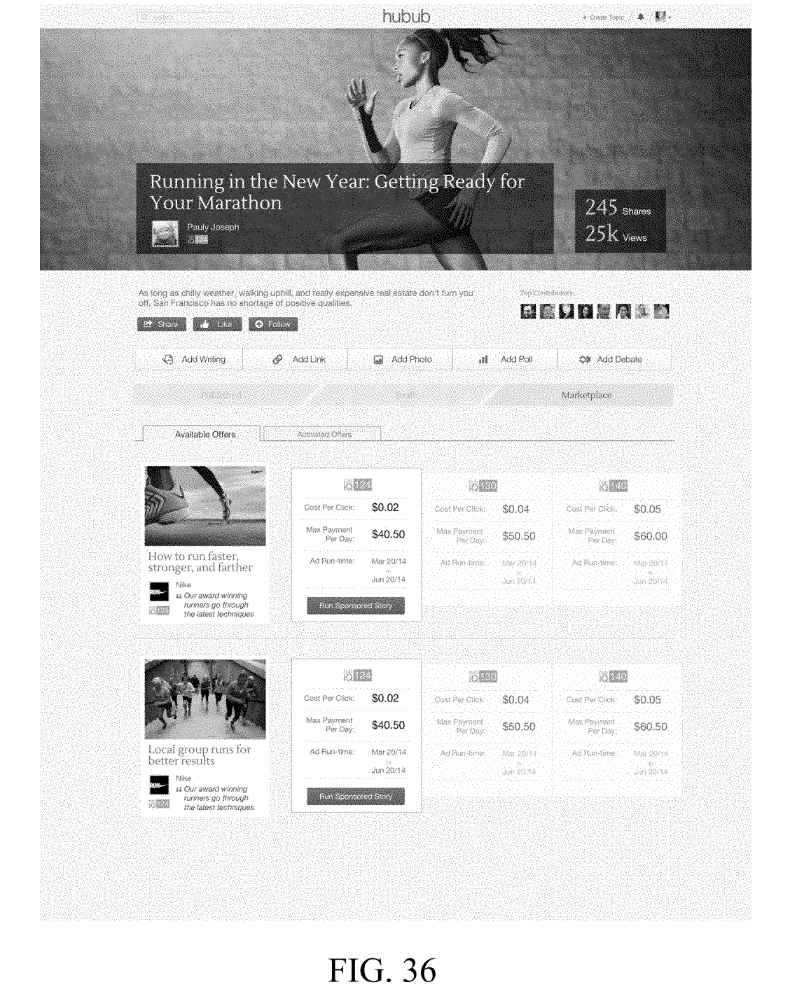

With reference to FIGS. 36-41, in an embodiment, the disclosed system and method provides a sponsored content system and method for publication and interactive discussion engines. As noted above, in an embodiment of the presently disclosed system and method, ownership of user-generated content can stay with the user who posted it. In addition, ownership of, and the ability to curate, an entire topic page or multiple related topic pages on the system can remain with their creator. This empowers each creator to create and then tend his own topic page or pages. The present invention provides, among other things, incentive for such an owner/curator to curate his or her topic pages in a manner that drives revenue to the system from third party sponsors by compensating owner/curators for publishing or curating sponsored content on their published topic pages.

To implement this, the system and method in an embodiment can provide the capability to (1) receive prospective sponsored content from a third party sponsor, e.g., a brand, (2) identify one or a plurality of published topic pages and/or owners/curators of published topic pages on the system who are good candidates to publish the sponsored content on their topic page(s), (3) formulate and make one or more offers of compensation to the identified owners/curators in exchange for publishing and/or curating the prospective sponsored content, (4) receive an indication of acceptance of such offer from at least one owner/curator, (5) identify prospective voters to approve or disapprove the draft sponsored content, (6) publish the sponsored content in a draft version of a topic page and make that draft version available to the prospective voters, (7) receive votes from the prospective voters, (8) publish the sponsored content on one or more published topic pages of the at least one owner/curator if the content has received at least a predetermined number or percentage of votes, (9) monitor impressions and/or clicks associated with the published sponsored content, and (8) compensate or facilitate compensation of the at least one owner/curator of the one or more published topic pages. Each of the above functions may be automated so as to be performed by a machine comprising software running on computing hardware. The above functions are discussed in detail below and reflected in FIGS. 36-41.

### (1) Receipt of Prospective Sponsored Content

In an embodiment, the system provides a web interface for receiving prospective sponsored content from third-party sponsors. Such prospective sponsored content may be, e.g., an article containing expert advice written by the staff of the sponsor, as discussed above. The sponsored content may comprise text, images, video, audio, or any combination thereof. Third-party sponsors are typically corporate brand owners desiring to market their goods or services and/or enhance their brand. A third-party sponsor uses the web interface to upload the content and information concerning the content, including, e.g., a level of compensation that the sponsor is willing to provide in exchange for publication and/or curation of the prospective sponsored content on published topic pages, and key words/phrases or hash tags associated with the prospective sponsored content. The system can be configured to automatically examine prospective sponsored content to identify key words associated therewith. Interfaces other than web interfaces may be utilized to practice the invention.

(2) Identification of Candidate Topic Pages and/or Candidate Owners/Curators for Publication of Prospective Sponsored Content

The system can incorporate multiple factors in identifying relevant topic pages and/or candidate owners for publication of the prospective sponsored content. For example, the system can match key words submitted by the sponsor to key words or hash tags associated with topic pages; the system can factor in the HubIQ score (discussed above) of owners/curators on the system, giving preference to owners with higher scores; the system can factor in the information provided by the sponsor when the prospective sponsored content was submitted; the system can factor in the popularity of a particular owner's published topic page or particular content on such published topic page. The system can be configured to require that a particular published topic page mature to a particular level before its owner can begin to be compensated for running sponsored content.

### (3) Formulating and Making Offers of Compensation

FIG. 36 shows an example of a page for presenting offers of compensation an owner/curator of a topic page for publishing a piece of sponsor content on his or her topic page. In this example, two offers are being presented. The first is an offer of $0.02 per click (up to a maximum of $40.50 per day) to run a sponsored article entitled “How to run faster, stronger, and farther” between March 20 and June 20. The second offer is similar except it is for an article entitled “Local group runs for better results.” While the offer is being presented by the system, it can be funded by the system and/or the sponsor themselves (in this case, a footwear company). The system can be configured to determine a revenue sharing ratio between the proprietor of the system and the owner/curator in a number of ways. For example, the proportion of the sponsorship dollars that are given to the owner/curator can be relatively high for those owners/curators who have a relatively high HubIQ score and relatively low for those owners/curators who have a relatively low HubIQ score. The system can factor in how well key words submitted by the sponsor match key words or hash tags associated with owner/curator's topic page; the system can factor in the popularity of a particular owner's published topic page or particular content on such published topic page. As shown in the example of FIG. 36, the owner/curator to which the offers are being made has a HubIQ score of 124, which merits a compensation of $0.02 per click, but the offer page also presents compensation levels that the owner/curator could make if he or she had a higher score of 130 ($0.04 per click) or an even higher score of 140 ($0.05 per click). Other bases for compensation can be used, including a pay-per-impression basis, a flat fee basis, an auction system that allows owners/curators or sponsors to bid for compensation levels, or a pay-per-action basis in which an owner/curator is compensated for each action that is taken by a user that benefits the sponsor. Such actions include, for example, users signing up for a guided tour that is offered by the sponsor.

As the number of members of the topic page's community rise, the owner/curator's HubIQ can rise proportionally and the level of compensation that the owner/curator receives can rise accordingly; thus, the system incentivizes owners/curators to bring more people to view and/or become a member of his or her topic page.

### (4) Receiving Acceptance

The owner/curator is free to accept or not accept each of the offers presented, depending upon whether he or she desires to have such sponsored content appear on the topic page(s) which he or she owns/curates. By accepting some offers and not others, the owners/curators are effectively voting on the relevance and attractiveness of the sponsored content. The offer page shown in FIG. 36 includes a “Run Sponsored Story” button which can be activated by the owner/curator to accept the offer.

### (5) Identification of Prospective Voters to Approve the Draft Sponsored Content

Once an offer has been accepted, the prospective sponsored content is published in a draft version of the owner/curator's topic page. This version is only made available to a select number of users, who will vote on the prospective content to determine whether it should be published on the published topic page that is more widely available to all users or a larger subset of users. Prospective voters to view and vote on the content before publication can be selected at random from members of a community associated with the relevant topic page.

(6) Publication of the Sponsored Content in a Draft Version of a Topic Page and Making that Draft Version Available to the Prospective Voters

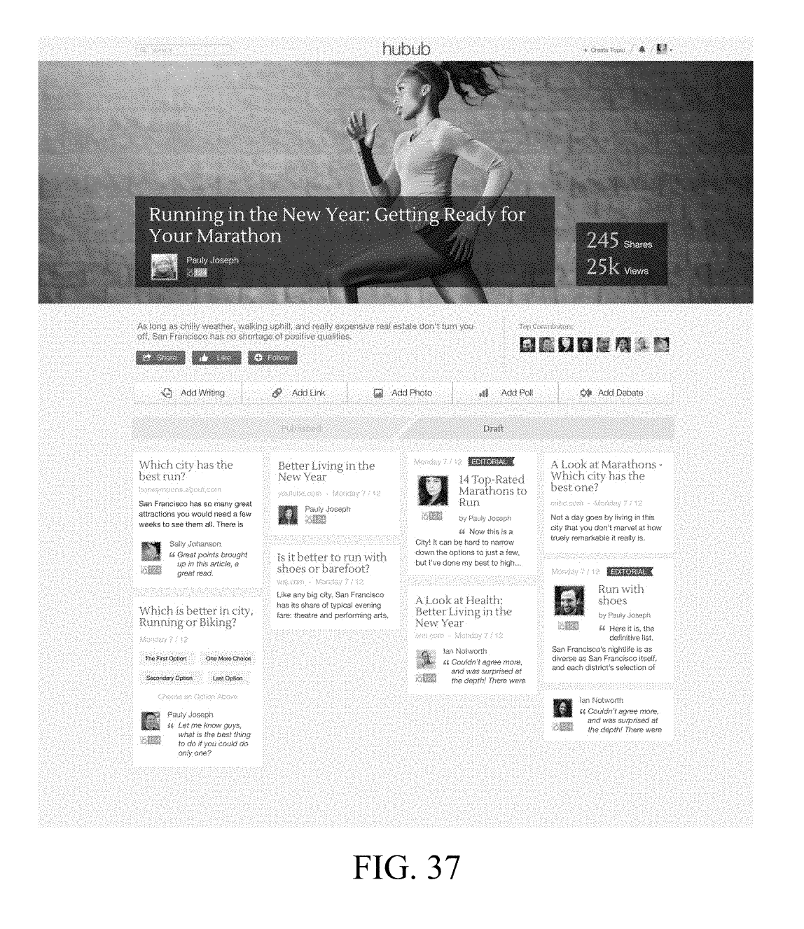

Once the prospective voters have been identified, the prospective sponsored content is published in a draft version of the owner/curator's topic page and that version is made available to the voters. FIG. 37 shows an example of a page presenting a draft version of an owner/curator's topic page. In this example, Sally Johanson has accepted an offer to run a sponsored article and posted a comment “Great points brought up in this article, a great read.”

(7) Receiving Votes from the Prospective Voters

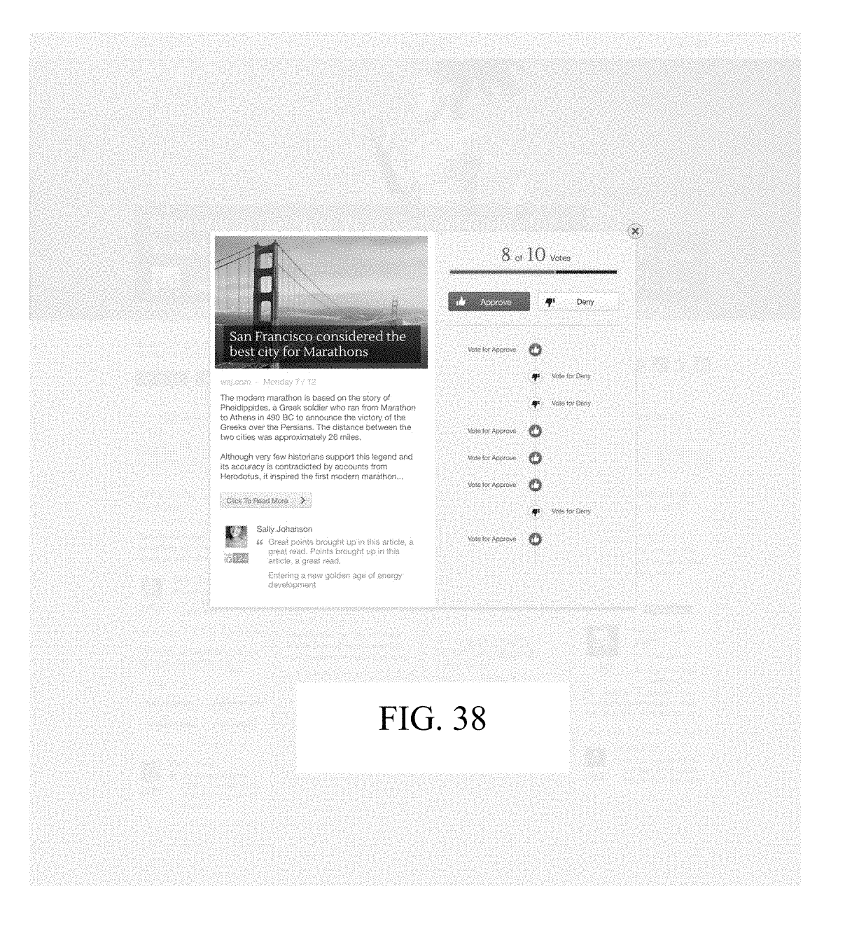

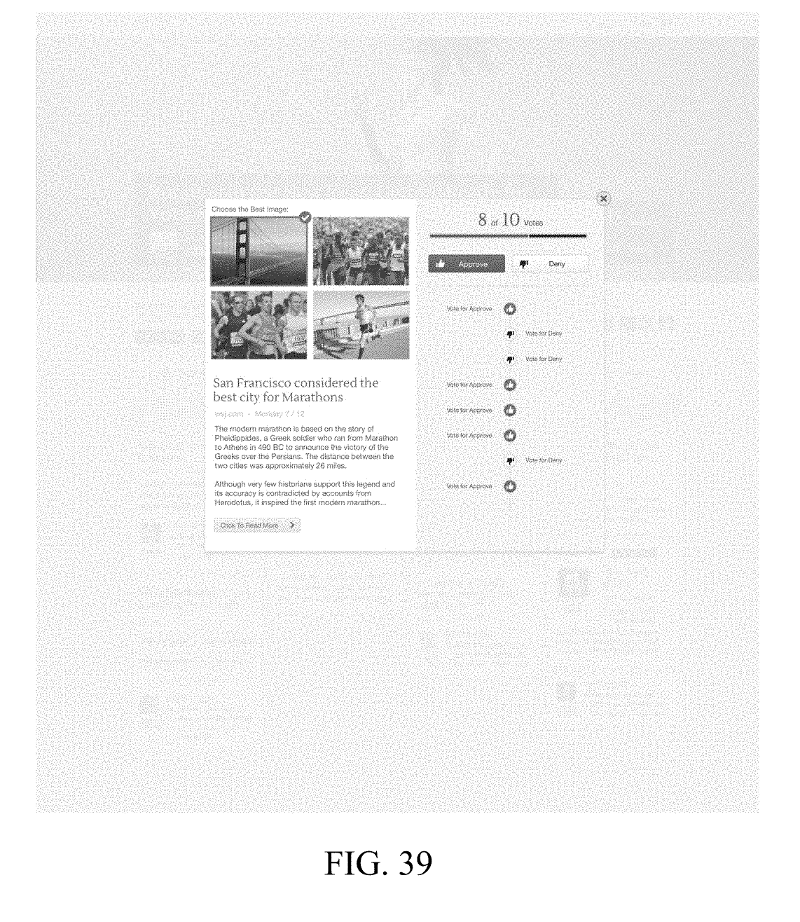

FIG. 38 shows an example of a page presenting an interface for rating/approving a draft prospective sponsored article. As shown, the article has received 8 approvals out of 10 votes. FIG. 39 shows an example of a page presenting an interface for rating/approving images associated with a draft prospective sponsored article. This interface is used to allow the voters to select an image to be used along with the article. The system can be configured to provide to the sponsor statistical feedback regarding the approval level that the voters gave to various different pieces of the sponsor's sponsored content.

### (8) Publishing the Sponsored Content on Published Topic Page

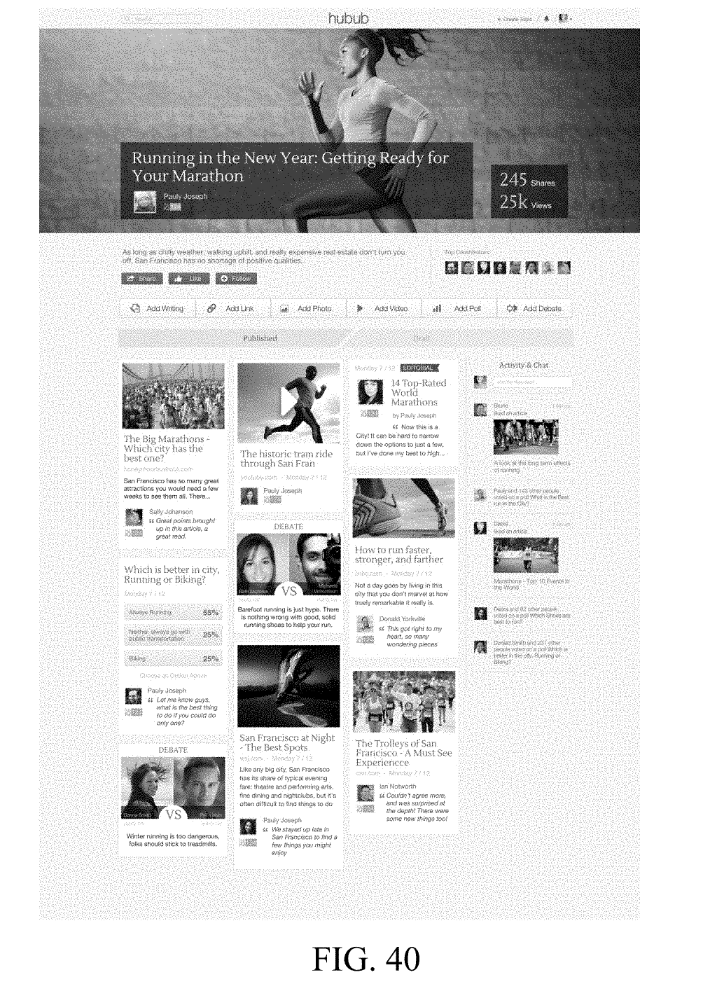

If the content has received at least a predetermined number of votes, it is published on one or more published topic pages of the at least one owner/curator. In the case discussed above, the sponsored content has received 8 out 10 approvals, and so it is published in the widely available published version of the owner/curator's published topic page. FIG. 40 shows an example of a page presenting a published version of an owner/curator's topic page, including the sponsored content that was discussed above.

(9) Monitoring Impressions and/or Clicks Associated with the Published Sponsored Content

During the time that the sponsored content is being run on the published topic page, the system can monitor the number of clicks on the content, the number of impressions of the page that includes the content, the owner/curator's HubIQ, the popularity of the content as determined by voting, and other factors. The system can automatically adjust the compensation level paid to the owner/curator, the compensation level being paid by the sponsor, the owner/curator's HubIQ, the priority that the topic page receives in search results on the system, and the like, based upon such monitoring.

(8) Compensating or Facilitating Compensation of the Owner/Curator of the Published Topic Page

The owner/proprietor is compensated in accordance with the terms of the offer. Such terms may be modified during the run time of the sponsored content based, e.g., on the monitoring described above. The owner/curator may be compensated directly by the sponsor or may be compensated by proprietor of the system.

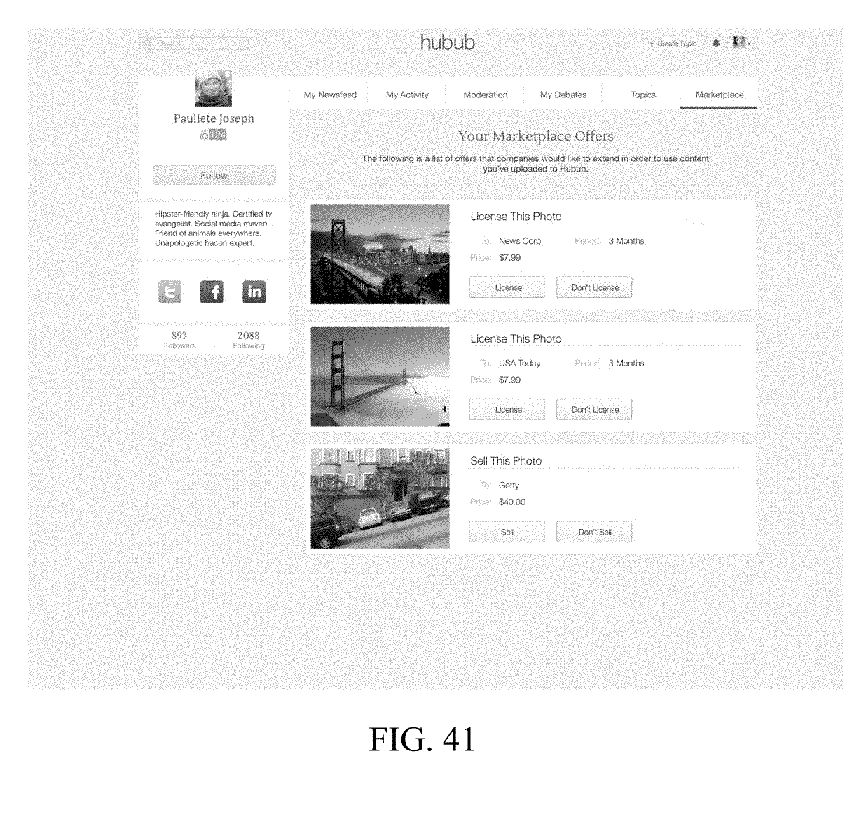

FIG. 41 shows an example of a page presenting an interface that allows a user to license out photographs that he or she has uploaded to the system to third parties.

### Third Party Site Integration

The presently disclosed publication engine allows a Brand to communicate and build interactive communities directly on third parties' sites, thereby extending the Brand's reach and engagement at the time the users want to engage with the brand.

The presently disclosed system and method provides a publication engine that allows not only building of the above-described dynamic, interactive topic pages on a Brand's site, but then further allows the Brand to publish that interactive topic, real-time communication page on third-party sites, such as the sites of media partners, so they can reach, interact and communicate with the third-party site users that wish to engage. In this manner, the Brand's topic page becomes the central node and, utilizing the disclosed system and method, the Brand can create sub-nodes on each of a plurality of other sites with which they wish to partner. The sub-nodes are essentially sub-communities to the main node.

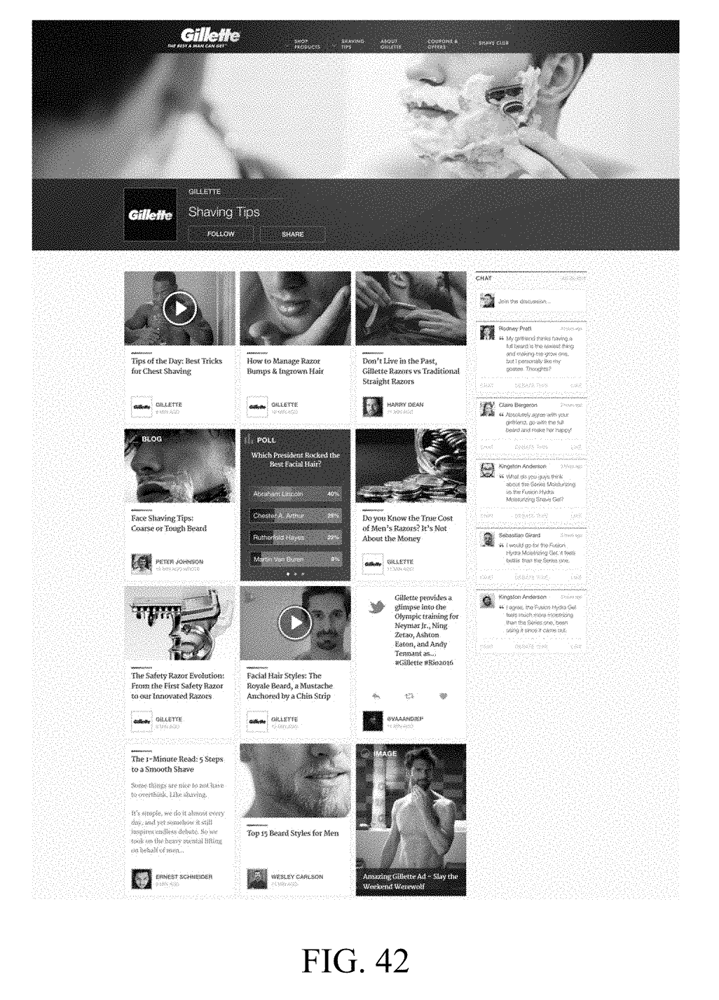

With reference to FIG. 42, the presently disclosed system and method allows a Brand or Product site, such as Proctor & Gamble in this example, to create a topic community around their products or services. In such topic community, users can engage with each other and the brand.

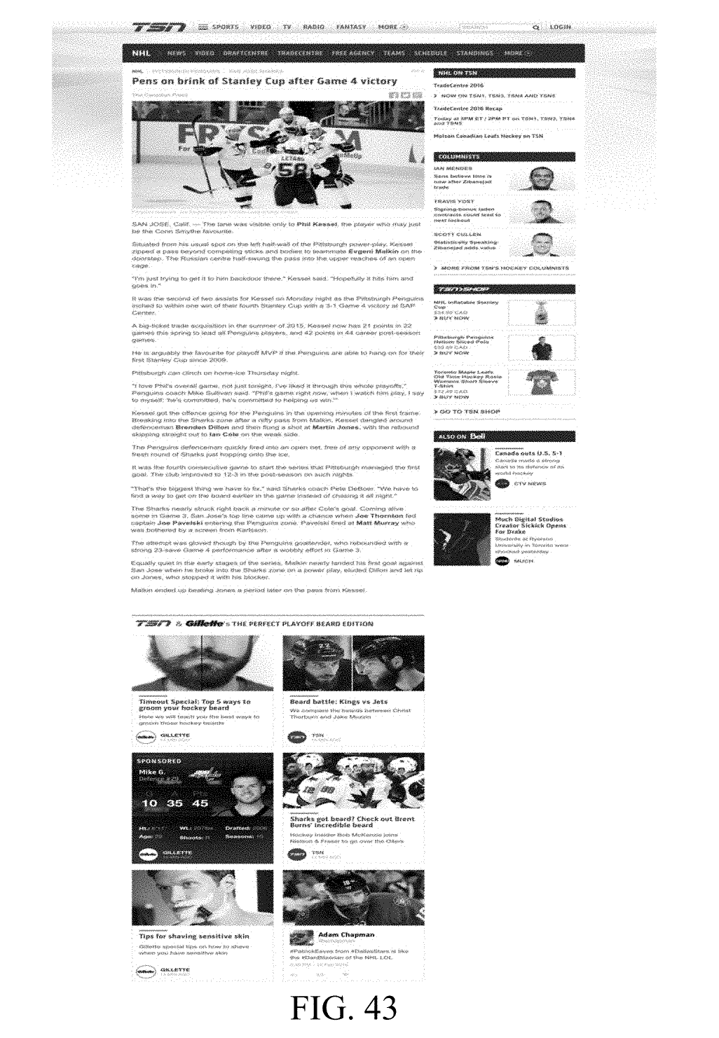

With reference to FIG. 43, the system and method disclosed herein then allows the Brand to partner up with third-party Partner's sites and sponsor or co-promote their communities on the appropriate Partner (TSN in this example) web/mobile pages. This can be done automatically through a system-derived matching algorithm, or manually via an editor.

The disclosed system and method then enables the Partner to embed the entire or selected parts of the Brand's community directly onto the Partner's site or, in an embodiment, any other third-party Partner that chooses to partner with the Brand. The presently disclosed system and method, in an embodiment, provides the capability for a consumer/user of the Partner to engage in the Brand's (e.g., Proctor & Gamble's) community directly on the Partner's web/mobile site. The Brand essentially creates a node for its community, thereby extending its reach and ability to address a wider customer/user base. As the Partner's customer/user engages on that particular node in the Brand's community by posting or commenting or using the various functions or tools, all such activities are sent directly back to the Brand's main/central node, where all the posts can be moderated before posting the update to all the partner nodes. Now, the Partner site can choose to moderate all the posts that are presented to their site independently or choose to defer to the central node. Also, the Partner node can exclude specific users or content that it deems not appropriate for its node.

In an embodiment, the disclosed system is configured to perform machine learning on how users engage with the content, and with the community, and on which products they engage. This allows the system to profile the user better and gain an understanding of brand sentiment, brand interest and intent to purchase by geography and demographics.

The system can be configured such that each embed into a third-party site can become a node in the network where the branded site is the center of the network.

The system can be configured such that any posts or other engagements are shared automatically throughout the network wherever the component is embedded.

The system can be configured with the added ability to allow each third-party site (node) to moderate and filter out key words and block users they do not want in their community on their 3rd party site.

In an embodiment, a master set of engagements always exists on the branded site.

The above-described system and method allows the brand to communicate with an audience on other sites and expand their reach and capabilities, thereby providing a very effective way to create valuable content and dialogue for the brand customers, more revenue for the third-party sites, and an effective tangible and measurable engagement with the users.

In an embodiment, the system is configured to provide the capability of the third-party sites to earn money or other valuable compensation. This can be accomplished by configuring the system to support co-promotional deals with the brands which the system measures and performs verification on user metrics from views, unique views, clicks, time on page, number of content created, engagements using all the components, shares, recurring visits and purchases or conversion on actions.

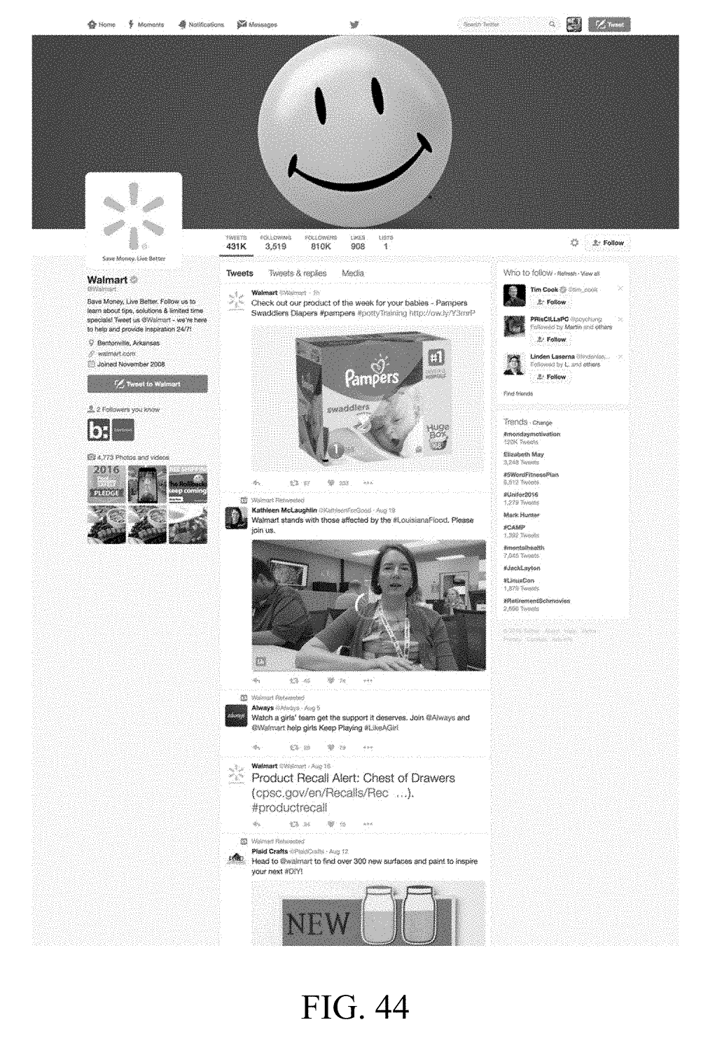

With reference to FIG. 44, in an embodiment, the promotion capabilities extend not only to leveraging social media but being able to automatically or manually embed content in the Partner or Brand's social streams.

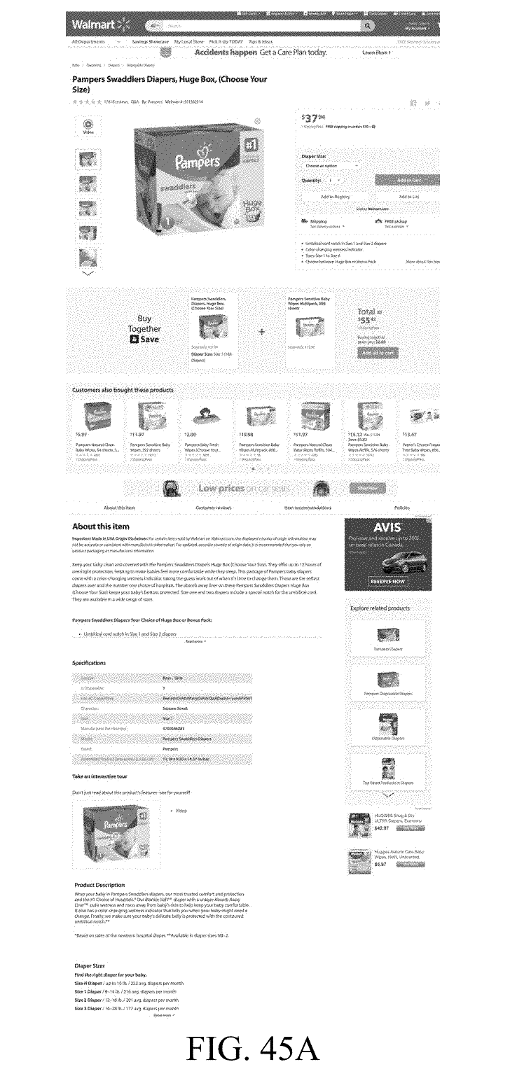

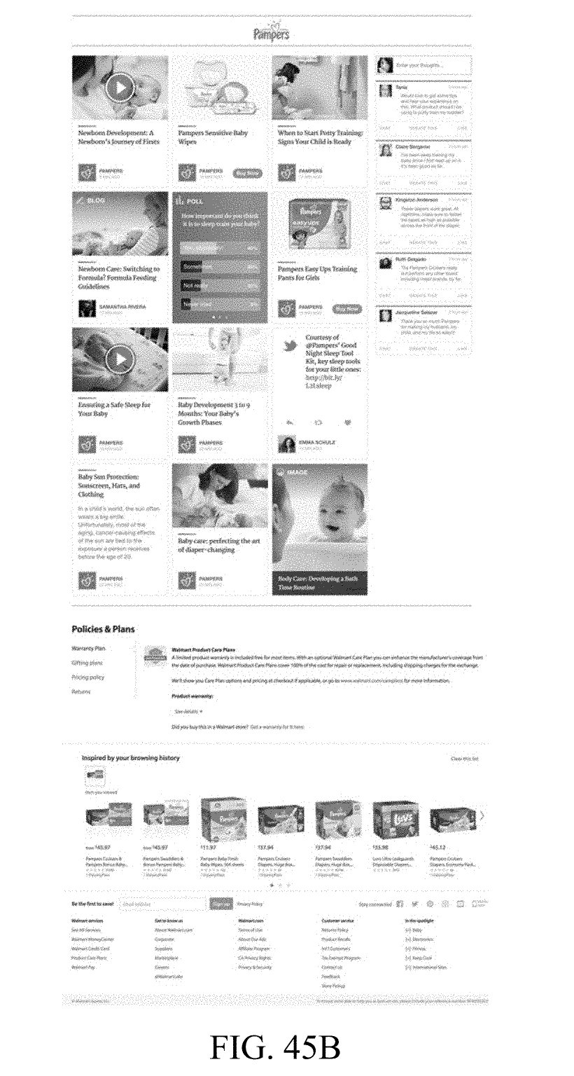

FIGS. 45A and 45B show another illustrative example wherein a Retailer is the Partner, co-promoting with a Brand such as Pampers. In this embodiment, the user and/or the system identifies a relevant piece of content in a Twitter stream and the system sends the user to right node. In this case, it is the user is sent directly to a Retailer's product page (such as Walmart's product page). Note the Pampers community below it. Using the system and method according to this embodiment, the user is able to communicate not only with the Brand but with a wider Product (e.g., Pampers) community and user base to share knowledge, tips and ideas or questions, etc. In an embodiment, the presently disclosed system and method has the ability to customize the node to the Brand's needs.

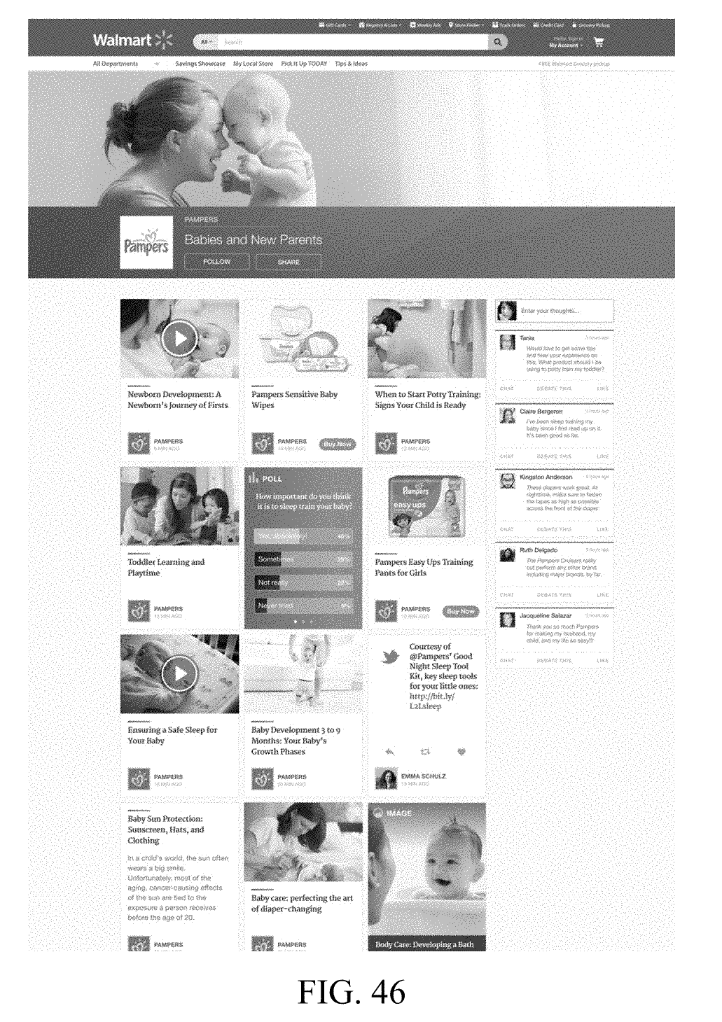

FIG. 46 shows another example of a node on a Retailer's site. In this embodiment, the content, users, and all aspects of the look and feel can be customized

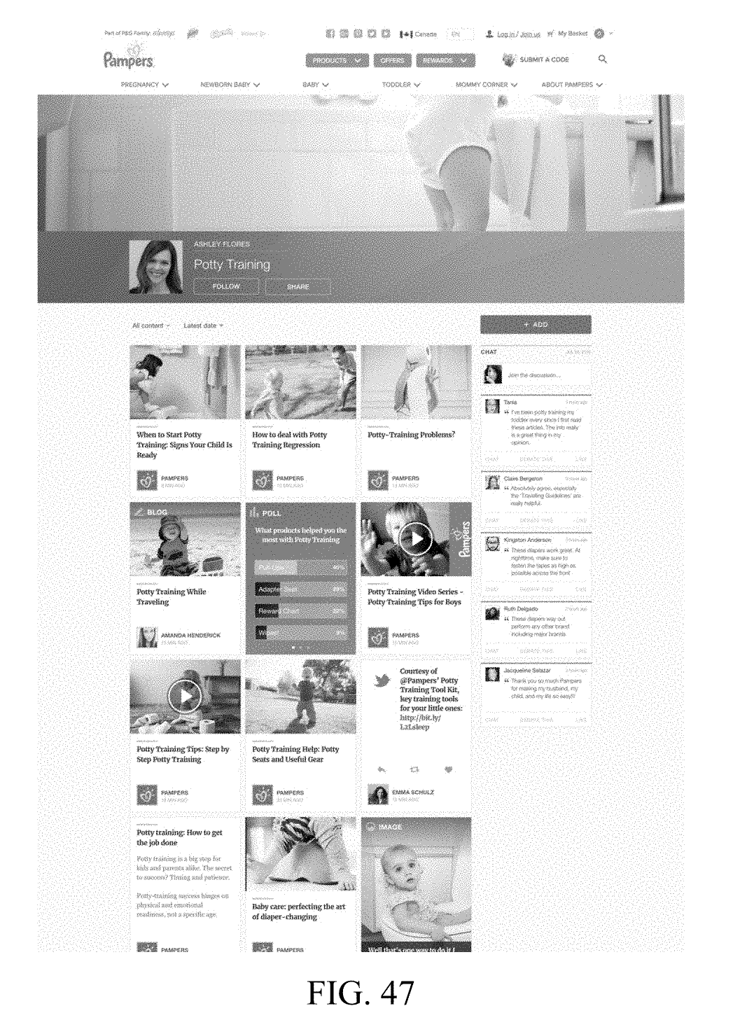

FIG. 47 illustrates an embodiment wherein the above is just a subset of the master central node on the Brand's site.

In an embodiment, a machine is provided that is useful in serving web pages. The machine provides a publication engine which allows building of dynamic, interactive topic pages on a Brand's site, and further allows the Brand to publish dynamic, interactive topic pages on third-party sites. The system includes a data store containing data for populating a front end interface and a computer system having at least one server with a physical data processor operatively coupled to the data store. The physical data processor is programmed to receive data representing a topic via a computer network from a Brand user, the topic having been selected by the Brand user and relating a product or service of the Brand; receive across the network an identification from the Brand user of multiple forms of interactive content that pertains to the topic; build one or more web-accessible topic pages having dynamic content that is relevant to the topic along with interactive means for provoking participation of multiple users regarding the topic and the content; transmit the one or more web-accessible topic pages across the network to the user's computer for display; receive from a third party an identification of a web site of the third party into which at least a portion of the one or more web-accessible topic pages are to be integrated; and, in response to a content request from a server running the third party web site, send to the server of the third party web site content of the at least a portion of the one or more web-accessible topic pages for integration into the page requested by the end user.

Thus, there has been disclosed above a system and method that achieves substantial technical benefits over conventional web servers, such as increased flexibility, faster publication times, and less human supervision.

Reference in the specification above to “an embodiment” or “the embodiment” means that a particular feature, structure, or characteristic described in connection with the embodiment is included in at least an embodiment of the disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention is described above with reference to diagrams and operational illustrations of methods and devices to serve interactive topic pages. It is understood that each of the diagrams or operational illustrations, and combinations thereof, may be implemented by means of analog or digital hardware and computer program instructions. These computer program instructions may be stored on computer-readable media and provided to a processor of a general purpose computer, special purpose computer, ASIC, or other programmable data processing apparatus, such that the instructions, which execute via the processor of the computer or other programmable data processing apparatus, implements the functions/acts specified in the diagrams or the specification above. In some alternate implementations, the functions/acts noted in this specification or the diagrams may occur out of the order noted in the operational illustrations.

At least some aspects disclosed can be embodied, at least in part, in software. That is, the techniques may be carried out in a special purpose or general purpose computer system or other data processing system in response to its processor, such as a microprocessor, executing sequences of instructions contained in a memory, such as ROM, volatile RAM, non-volatile memory, cache or a remote storage device. Functions expressed in the claims may be performed by a processor in combination with memory storing code and should not be interpreted as means-plus-function limitations.

Routines executed to implement the embodiments described above may be implemented as part of a software application, an operating system, firmware, ROM, middleware, service delivery platform, SDK (Software Development Kit) component, web services, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in their entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

The above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention. The above description and drawings are merely illustrative of the present invention and that changes in components, structure and procedure are possible without departing from the scope of the present invention as defined in the following claims. For example, elements and/or steps described above and/or in the following claims in a particular order may be practiced in a different order without departing from the invention. Thus, while the invention has been particularly shown and described with reference to embodiments thereof, it will be understood by those skilled in the art that various changes in form and details may be made therein without departing from the spirit and scope of the invention.

1. A system comprising a machine, useful in serving web pages, that provides a publication engine which allows building of dynamic, interactive topic pages on a Brand's site, and further allows the Brand to publish dynamic, interactive topic pages on third-party sites, the system comprising:
(a) a data store containing data for populating a front end interface;
(b) a computer system comprising at least one server having a physical data processor operatively coupled to the data store, the computer system programmed to:
i) receive data representing a topic via a computer network from a Brand user, the topic having been selected by the Brand user and relating a product or service of the Brand;
ii) receive across the network an identification from the Brand user of multiple forms of interactive content that pertains to the topic;
iii) build one or more web-accessible topic pages having dynamic content that is relevant to the topic along with interactive means for provoking participation of multiple users regarding the topic and the content;
iv) transmit said one or more web-accessible topic pages across the network to the user's computer for display;
v) receive from a third party an identification of a web site of the third party into which at least a portion of the one or more web-accessible topic pages are to be integrated; and,
vi) in response to a content request from a server running the third party web site, the request being sent in response to a request for a page from an end user of the third party web site, send to the server of the third party web site content of the at least a portion of the one or more web-accessible topic pages for integration into the page requested by the end user.

2. The system according to claim 1, wherein the computer system is further programmed to:
vii) receive directly or indirectly from the server running the third party web site engagements posted to the server running the third party web site by the end-user of the third party web site; and,
viii) incorporate the engagements posted to the server into the one or more web-accessible topic pages.

3. The system according to claim 2, wherein the engagement posted to the server comprises a comment.

4. The system according to claim 2, wherein the engagement posted to the server comprises a poll response.

5. The system according to claim 2, wherein the computer system is further programmed to moderate the engagement posted to the third party server before updating the one or more web-accessible topic pages with the engagement posted to the third party server.

6. The system according to claim 1, wherein the third party is a media partner of the Brand.

7. The system according to claim 1, wherein the third party is a retailer of the Brand.

8. The system according to claim 1, wherein the computer system is further programmed to function as a central node on a network for the one or more web-accessible topic pages and to create sub-nodes on the network for at least a portion of the one or more web-accessible topic pages on each of a plurality of other web sites.

9. The system according to claim 7, wherein the computer system is further programmed such that posts or other engagements to a content component on one node of the network are shared automatically throughout a plurality of other nodes on the network wherever the content component is embedded.

10. The system according to claim 1, wherein the computer system is further programmed to perform machine learning as to at least one of: how users engage with content, how users engage with the community, and which products users engage with.

11. The system according to claim 1, wherein a master set of engagements is stored on the computer system, and the computer system is associated with the Brand.
